(19) United States
(12) Patent Application Publication
(10) Pub. No.: US 2015/0146967 A1
(43) Pub. Date: May 28, 2015

(54) PATTERN EVALUATION DEVICE AND PATTERN EVALUATION METHOD

(71) Applicant: Hitachi High-Technologies Corporation, Tokyo (JP)

(72) Inventors: Atsushi Miyamoto, Tokyo (JP); Toshikazu Kawahara, Tokyo (JP); Akihiro Onizawa, Tokyo (JP); Yutaka Hojo, Tokyo (JP)

(21) Appl. No.: 14/403,675

(22) PCT Filed: Apr. 24, 2013
(86) PCT No.: PCT/JP2013/061966

§ 371 Date: Nov. 25, 2014

(30) Foreign Application Priority Data
May 30, 2012 (JP) 2012-122638

(51) Int. Cl. G06T 7/00; G06T 3/40; G02B 21/36

(52) U.S. Cl. CPC G06T 7/001; G02B 21/365; G06T 3/40; G06T 2207/30141; G06T 2207/10056
USPC 382/145

(57) ABSTRACT

The present invention relates to a setting method for an image capture area on the occasion of evaluation of a circuit pattern using a scanning charged particle microscope. A circuit pattern that is to be evaluated using an actual image or design data is determined, a plurality of image capture areas are set such that the circuit pattern to be evaluated is included in a section of the field of vision, and images are captured of the plurality of image capture areas. When setting the image capture areas, a permissible value for the distance between adjacent first and second images is set, and the positions of the image capture areas are optimized so as to correspond as closely as possible with the permissible value for distance. As a result, it is possible to improve the throughput of image capture of wide inspection areas that do not fit in the field of vision of the scanning charge particle microscope, and to efficiently carry out determination of an inspection area that may cause electrical failure.

### TECHNICAL FIELD

The present invention relates to a method and apparatus for effectively inspecting a circuit pattern with a scanning charged particle microscope.

### BACKGROUND ART

In forming a circuit pattern on a semiconductor wafer, there is employed a method for forming a circuit pattern by applying a coating material (referred to as a resist) on the semiconductor wafer, stacking a mask (a reticle) for exposure of the circuit pattern on the resist and irradiating a visible ray, an ultra violet ray or an electron beam thereon to expose and develop the resist in order to form a circuit pattern of the resist on the semiconductor wafer, and further etching the semiconductor wafer with the circuit pattern of the resist as a mask, for example.

In design and manufacturing of semiconductor devices, it is important to manage dust emission in manufacturing devices such as exposing and etching devices, and to evaluate the shape of the circuit pattern formed on the wafer. Because the circuit pattern is very fine, image capturing and inspection are performed with a scanning charged particle microscope having a high image capture magnification.

The scanning charged particle microscopes include a scanning electron microscope (SEM), a scanning ion microscope (SIM) and the like. Further, SEM-type image capturing devices include a critical dimension scanning electron microscope (CD-SEM) or a defect review scanning electron microscope (DR-SEM).

A region imaged with the scanning charged particle microscope in order to evaluate the shape of the pattern is referred to as an evaluation point, hereinafter EP in short. In order to capture an image of the EP with a small image capture deviation amount and with a high image quality, a part or all of adjustment points, i.e. addressing points (hereinafter APs), autofocus points (hereinafter AFs), automatic astigmatism correction points (hereinafter ASTs) or auto brightness and contrast points (hereinafter ABCCs) are set as required and the EP is imaged after addressing, autofocus adjustment, automatic astigmatism correction, auto brightness and contrast adjustment in each adjustment points. The image capture deviation amount in the addressing is corrected by matching a SEM image in the AP whose coordinates are known and which is previously registered as a registered template and a SEM image observed in the actual image capture sequence, the deviation amount of the matching being considered as a deviation amount of the image capture position. The evaluation points (EPs) and adjustment points (APs, AFs, ASTs, ABCCs) are collectively referred to as image capture points. Size, coordinates and image capture conditions of the EPs, image capture conditions and an adjustment method of each adjustment point, an image capture sequence of each image capture point and the registered template are managed as an image capture recipe and the scanning charged particle microscope performs imaging of the EPs based on the image capture recipe.

Conventionally, the image capture recipe has been manually created by an operator, which is a task requiring much effort and time. On the other hand, a semiconductor inspection system is disclosed in which APs are determined based on design data of a circuit pattern of a semiconductor described in the GDS II format or the like and data in the APs is further cut out from the design data and registered in an image capture recipe as a registered template, in order to reduce a burden of the image capture recipe generation (PATENT LITERATURE 1: JP-A-2002-328015).

Further, a “panorama composition technology” is disclosed which generates a seamless image by connecting a plurality of images separately captured, as means of obtaining an image having a wide field of vision with the scanning charged particle microscope (PATENT LITERATURE 2: JP-A-2010-067516).

### CITATION LIST

### Patent Literature

### PATENT LITERATURE 1: JP-A-2002-328015

### PATENT LITERATURE 2: JP-A-2010-067516

### SUMMARY OF INVENTION

### Technical Problem

Conventionally, the quality of a circuit pattern in an evaluation point (EP) has been evaluated by imaging a region on a wafer as the EP with a fixed point inspection. However, it has been not easy to effectively inspect a disconnection or a shape defect in the circuit pattern, which can cause an electrical fault, with a scanning charged particle microscope, if coordinates of the EP are not determined as a fixed point. For example, even if an electrical fault such as a disconnection is found by a burn-in test in which a probe is applied on the circuit pattern at certain two points, it has been not easy to precisely specify where between the two points the problem occurs. This also applies to a case where it is not clear whether a fault is present or not and a fault inspection of certain circuit patterns having a same electrical potential is desired. This is because it is difficult to determine the inspection region that can be a cause of an electrical fault, and the inspection region is generally wide and cannot be fit in the field of vision of the scanning charged particle microscope. In the latter case, enlargement of the field of vision is expected with the panorama composition technology described in patent document 1, but an efficient inspection is difficult from the viewpoint of the number of imaging actions. Further, due to imaging with a low image capture magnification, the field of vision can be enlarged to some degree, but an image resolution is reduced, which results in a risk of reducing inspection performance.

### Solution to Problem

The present invention provides a method for effectively and automatically inspect a disconnection or a shape defect in the circuit pattern, which can cause an electrical fault, with a scanning charged particle microscope. In order to solve the problem, the present invention provides a method and apparatus for evaluating a circuit pattern having the following characteristics.

The present invention provides a method for evaluating a circuit pattern including: a permissible distance value specification step of specifying a permissible distance value, the permissible distance value being a permissible value of a distance between adjacent first image and second image included in a plurality of images obtained by imaging an evaluation pattern; an image capture region determination step of determining an image capture region which includes at least a part of the evaluation pattern and in which the distance between the adjacent images is smaller than the permissible distance value specified in the permissible distance value specification step; and an image capture step of performing imaging of the evaluation pattern in the image capture region determined in the image capture region determination step to obtain a plurality of images.

### Advantageous Effects of Invention

According to the present invention, a pattern inspection apparatus and a pattern inspection method for enhancing an inspection throughput of the circuit pattern can be provided.

### BRIEF DESCRIPTION OF DRAWINGS

FIG. 1 is a view showing a representative example of an image capture sequence according to the present invention.

FIG. 2 is a view showing a configuration of a SEM device for realizing the present invention.

FIG. 3 is a view showing a method of imaging signal amounts of electrons emitted from a semiconductor wafer.

FIG. 4 is a view showing an image capture sequence in a SEM device.

FIG. 5 is a view showing a variation of a distance between evaluation points (EP).

FIG. 6 is a view showing a processing sequence of the present invention including determination of an image capture sequence according to an off-line determination mode.

FIG. 7 is a view showing a variation of the image capture sequence.

FIG. 8 is a view showing a method for imaging a pattern having branches and a variation of an EP image capture range.

FIG. 9 is a view showing tracking and imaging of an electrical path in a multi-layer wiring.

FIG. 10 is a view showing tracking and imaging of an electrical path in a multi-layer wiring.

FIG. 11 is a view showing a method of determining the image capture sequence in consideration of attribute information.

FIG. 12 is a view showing a processing sequence of the present invention including determination of an image capture sequence according to an on-line determination mode.

FIG. 13 is a view showing a method of determining the image capture sequence according to the on-line determination mode.

FIG. 14 is a view showing a method of determining the image capture sequence according to the combined determination mode.

FIG. 15 is a view showing a configuration of a device system for realizing the present invention.

FIG. 16 is a view showing a GUI of the present invention.

FIG. 17 is a view showing a GUI of the present invention.

### DESCRIPTION OF EMBODIMENTS

The present invention provides, in design or manufacturing procedures of a semiconductor device, an apparatus and method for efficiently inspecting a disconnection or a shape defect in circuit patterns formed on a wafer, which can cause electrical failures, by imaging the circuit patterns with a scanning charged particle microscope which is an image capturing device. Although embodiments according to the present invention will be described hereinafter in respect of a scanning electron microscope (SEM), which is one of the scanning charged particle microscopes, the present invention is not limited to the SEM, but is applicable to other scanning charged particle microscopes such as a scanning ion microscope (SIM). Further, the present invention is not limited to inspection of the semiconductor device, but is applicable to inspection of samples having patterns required to be imaged and evaluated.

### 1. Image Capturing Device

### 1.1 SEM Components

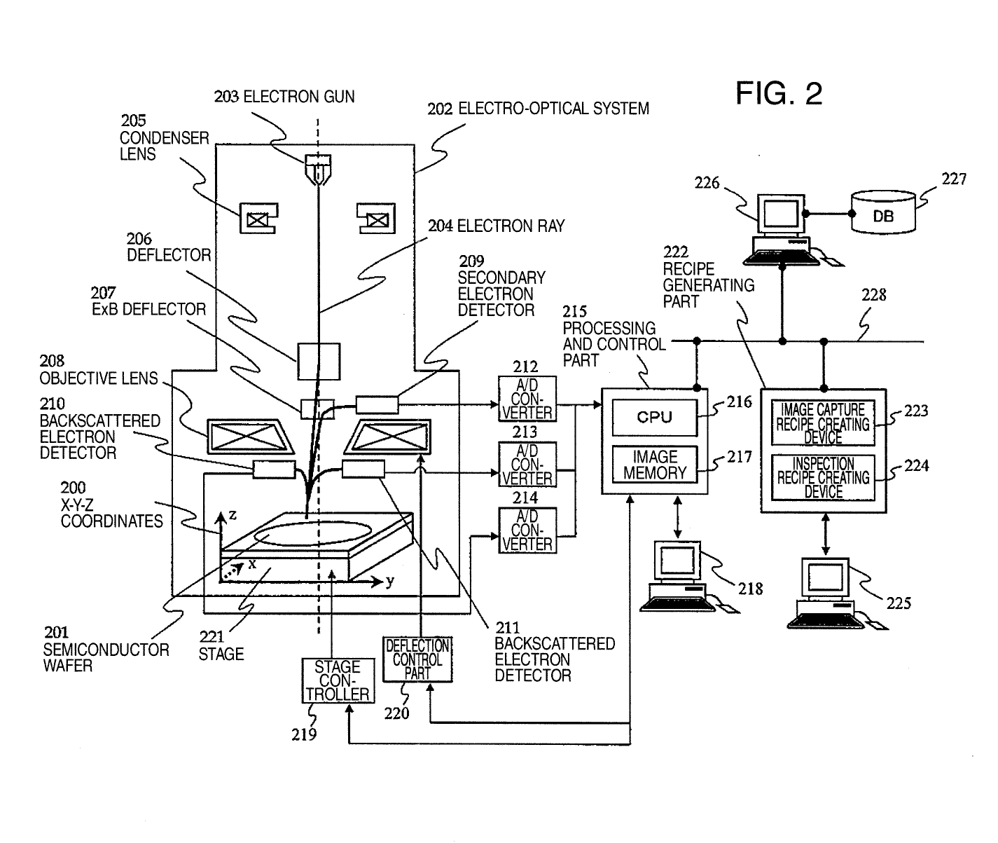

FIG. 2 shows an example of an inspection system according to the present invention. FIG. 2 shows an embodiment using a SEM as an example of a scanning charged particle microscope imaging a sample to be inspected, showing a block view of an overview of a configuration of the SEM capturing secondary electron (SE) images or backscattered electron (BSE) images of the sample. The SE images and BSE images are also collectively referred to as SEM images. Further, the images captured here include a part or all of a top-down image captured by irradiating an electron beam in a perpendicular direction to an object to be measured or a tilt image captured by irradiating an electron beam in any tilt directions.

An electro-optical system 202 includes an electron gun 203 therein to generate an electron ray 204. After making the electron ray emitted from the electron gun 203 narrower by a condenser lens 205, an irradiation position of the electron ray and a diaphragm are controlled by a deflector 206 and an objective lens 208 so that the electron ray is irradiated and focused onto a semiconductor wafer 201 which is a sample disposed on a stage 221. From the semiconductor wafer 201 irradiated with the electron ray, secondary electrons and backscattered electrons are emitted and the secondary electrons are diverted from the trajectory of the irradiating electron ray by an ExB deflector 207 so as to be detected by a secondary electron detector 209. On the other hand, the backscattered electrons are detected by backscattered electron detectors 210 and 211. The backscattered electron detectors 210 and 211 are arranged in different directions to each other. The secondary electrons and the backscattered electrons detected by the secondary electron detector 209 and the backscattered electron detector 210 and 211 are converted into digital signals by A/D converters 212, 213, 214 and then they are input to a processing and control part 215 and stored in an image memory 217 to perform image processing by a CPU 216 depending on purposes. Although the embodiment including two detectors for the backscattered electron image is shown in FIG. 2, the detectors for the backscattered electron image may be eliminated or the number of the detectors may be increased or decreased, and the direction of detection may be changed.

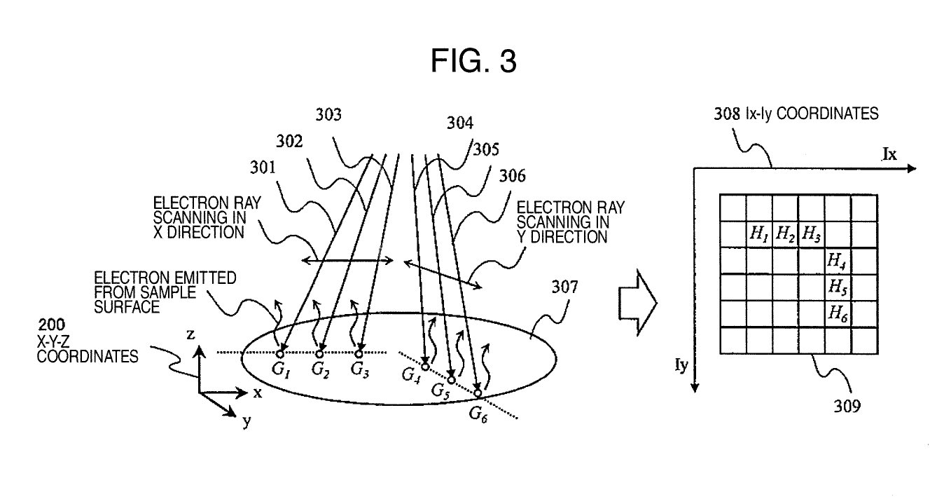

FIG. 3 shows a method of imaging signal amounts of the electrons emitted from the semiconductor wafer 307 when scanning and irradiating the electron ray on the semiconductor wafer 307. The electron ray are irradiated while scanning in the x and y directions as shown with reference numerals 301 to 303 or 304 to 306 on the left side of FIG. 3, for example. It is possible to change the scanning direction by changing a deflection direction of the electron ray. Positions on the semiconductor wafer, onto which the electron rays 301 to 303 scanned in the x direction are irradiated, are denoted by reference numerals G1 to G3, respectively. Similarly, positions on the semiconductor wafer, onto which the electron rays 304 to 306 scanned in the y direction are irradiated, are denoted by reference numerals G4 to G6, respectively. The signal amounts of the electrons emitted from the positions G1 to G6 provide brightness values of pixels H1 to H6 in an image 309 shown on the right side of FIG. 3, respectively (subscripts 1 to 6 for G and H correspond to each other). Reference numeral 308 denotes a coordinate system indicating the x and y directions on the image (referred to as Ix-Iy coordinate system). By scanning the electron ray in the field of vision in this way, an image frame 309 can be obtained. In practice, an image having a high S/N can be obtained by scanning the electron ray in the field of vision several times in a similar manner and calculating the arithmetic mean of the obtained image frames. The number of the frames to be added can be arbitrarily set.

The processing and control part 215 in FIG. 2 is a computer system including the CPU 216 and the image memory 217. The processing and control part 215 performs processing and control, such as sending a control signal to a stage controller 219 or a deflection control part 220 in order to capture an image of an image region including a circuit pattern to be evaluated, as an evaluation pattern based on an image capture recipe, or various image processes of the captured image of any evaluation pattern on the semiconductor wafer 201 based on a measurement recipe etc.

The details of the image capture recipe will be described hereinafter. The measurement recipe is a file specifying image processing algorithms and processing parameters for performing evaluation, such as defect detection, pattern shape measurement and the like in the captured SEM images. The SEM obtains inspection results by processing the SEM images based on the measurement recipe. Specifically, the measurement recipe is a method of determining a length measurement value of the pattern shape, a pattern contour line, an image characteristic amount for evaluating the pattern, a deformation amount of the pattern shape, a normality or abnormality of the pattern shape based on the above described information and the like, for each part of the evaluation pattern. The presence or absence of electrical failures or the degree of risk of electrical failures, even if electrical failures do not yet occur, can be quantitatively identified by observing changes in pattern shape or texture associated with changes in exposure conditions, optical proximity effect (OPE), electromigration or the like, presence or absence of sticking of foreign bodies originating from manufacturing devices or the like, or a position of the sticking (pattern deformation, disconnection or short between wirings is caused depending on the position of the sticking), etc.

Further, the processing and control part 215 is connected to a processing terminal 218 (which includes an input and output means, such as a display, a keyboard or a mouse) and includes a graphic user interface (GUI) displaying the images or the like to the user or accepting inputs from the user. Reference numeral 221 denotes a XY stage, which moves the semiconductor wafer 201 to allow image capturing at any position of the semiconductor wafer. Changing the image capture position with the XY stage 221 is referred to as a stage shift, and changing the observation position by deflecting the electron ray with the deflector 206 or the like is referred to as an image shift. Generally, the stage shift provides a wider range of motion, but provides a lower positioning accuracy of the image capture position, in nature. On the contrary, the image shift provides a narrower range of motion, but provides a higher positioning accuracy of the image capture position, in nature.

A recipe generating part 222 in FIG. 2 is a computer system including an image capture recipe creating device 223 and a measurement recipe creating device 224. The recipe generating part 222 is connected to a processing terminal 225 and includes a GUI displaying the generated recipe to the user or accepting settings for the imaging or the recipe generation from the user. The processing and control part 215 and the recipe generating part 222 described above can transmit and receive information via a network 228. A database server 226 with a storage 227 is connected to the network in order to save and share a part or all of (a) design data (design data for masking (without/with optical proximity correction (OPC)), design data of a wafer transfer pattern), (b) simulated shapes of actual patterns estimated from the design data for masking with litho-simulation or the like, (c) generated image capture and measurement recipes, (d) captured images (OM images, SEM images), (e) imaging and inspection results (a length measurement value of the pattern shape, a pattern contour line, an image characteristic amount for evaluating the pattern, a deformation amount of the pattern shape, a normality or abnormality of the pattern shape and the like, for each part of the evaluation pattern), (t) determination rules for the image capture and measurement recipes, linked with product types, manufacturing processes, date and time, data acquisition devices or the like. The processes performed in the parts 215, 222, 226 may be separately performed in any combination in a plurality of devices or integrally performed.

### 1.2 Image Capturing Recipe

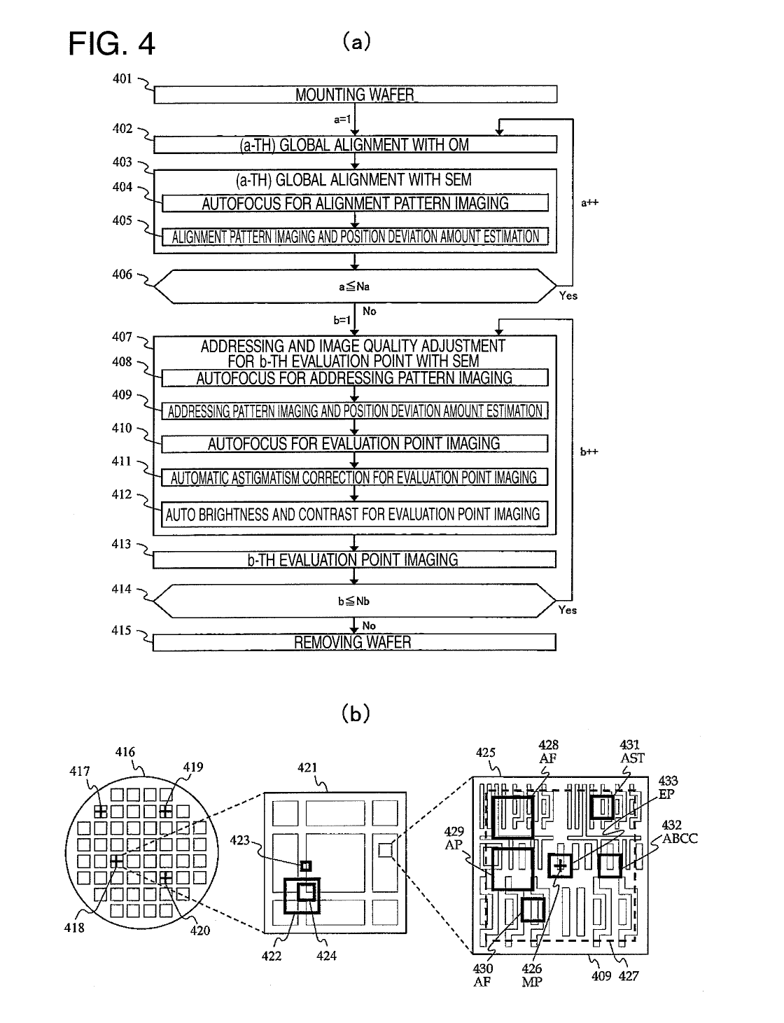

An image capture recipe is a file specifying an image capture sequence of the SEM. In other words, the image capture recipe specifies coordinates of an image capture region to be imaged as an evaluation target (referred to as an evaluation point (EP)), and an imaging procedure for imaging the EPs without a position deviation and with a high precision. A plurality of EPs may be present on one wafer and the EPs cover the entire wafer for inspection of the entire surface of the wafer. FIG. 4(a) shows a flow diagram of a representative image capture sequence for imaging the EPs and FIG. 4(b) shows image capture positions corresponding to the representative image capture sequence. The image capture sequence will be described hereinafter, while corresponding FIG. 4(a) to FIG. 4(b).

Firstly, in step 401 of FIG. 4(a), a semiconductor wafer (reference numeral 201 in FIG. 2 or reference numeral 416 in FIG. 4(b)) as a sample is mounted on the stage 221 of the SEM device. In FIG. 4(b), rectangular frames such as represented by reference numerals 417 to 420 drawn in the wafer 416 denote chips and reference numeral 421 denotes a chip 418 in an enlarged manner. Further, reference numeral 425 denotes a part of a chip 421 in an enlarged manner with a EP 433 being in the center. In step 402, with the stage shift, the field of vision of an optical microscope (not shown in FIG. 2) mounted on the SEM is moved to a predetermined alignment pattern on the wafer in order to observe the alignment pattern on the wafer with the optical microscope and obtain an OM image. A deviation amount of the wafer is calculated by matching the data (template) for matching in the alignment pattern, which is previously prepared, and the OM image. In FIG. 4(b), an image capture range of the alignment pattern is shown by a thick frame 422.

The accuracy of the deviation amount determined by the matching can be not sufficient, because the image capture magnification of the OM image in step 402 is low. Therefore, in step 403, a SEM image is captured by irradiation of the electron ray 204 and alignment is performed with the SEM image. Although there is a risk of the pattern to be imaged being out of the FOV depending on the deviation amount of the wafer because the FOV of the SEM is lower than the FOV of the optical microscope, an approximate deviation amount is known from step 402 and the irradiation position of the electron ray 204 is moved in consideration of the deviation amount. Specifically, firstly, in step 404, the image capture position of the SEM is moved to an autofocus pattern for alignment pattern imaging 423 and imaging is performed to determine a parameter of autofocus adjustment. Then, the autofocus adjustment is performed based on the determined parameter. Next, in step 405, the image capture position of the SEM is moved to an alignment pattern 424 and imaging is performed. Then, by matching the data (template) for matching in the alignment pattern 424, which is previously prepared, and the SEM image, a more accurate deviation amount of the wafer is calculated. FIG. 4(b) shows an example of the image capture positions of the alignment pattern for the optical microscope 422, the autofocus pattern for alignment pattern imaging for the SEM 423 and the alignment pattern for the SEM 424. In selection of these image capture positions, it is required to consider whether a pattern suitable for performing alignment or autofocus is included therein.

Alignments with the optical microscope and the SEM in steps 402, 403 are performed at a plurality of positions on the wafer and a large origin deviation of the wafer and rotation of the wafer are calculated based on the position deviation amount determined at the plurality of positions (global alignment). In FIG. 4(a), alignment is performed at Na positions (steps 402 to 406). FIG. 4(b) shows an example wherein alignment is performed at four positions, i.e. chips 417 to 420. Thereafter, when moving the field of vision to desired coordinates, the movement is performed so as to cancel the origin deviation and rotation determined here.

On completion of alignment on the wafer level, in step 407, more accurate positioning (addressing) and image quality adjustment are performed for each evaluation pattern (EP) to capture an image of the EP. The addressing is performed in order to cancel a stage shift error which occurs when moving the field of vision to each EP. Specifically, firstly, the stage shift to the EP 433 is performed. In other words, the stage 221 is moved so that the vertical incidence position of the electron ray 204 is the center of the EP. The vertical incidence position of the electron ray 204 is referred to as Move coordinates (hereinafter, MP) and shown by a cross mark 426. Although an example wherein the MP is set at the center position of the EP will be described here, the MP may be set on the periphery of the EP. Once the MP 426 is determined, the stage is no longer moved from there and a range 427 (dotted frame), in which the field of vision can be moved, is determined only with the image shift. Of course, in practice, there is a deviation by the amount of a stop error in the stage shift, even if the stage shift is performed to the MP. Next, in step 408, the image capture position of the SEM is moved to an autofocus pattern for addressing pattern imaging 428 (hereinafter, AF) with the image shift and imaging is performed. Then, a parameter of the autofocus adjustment is determined and the autofocus adjustment is performed based on the determined parameter. Next, in step 409, the image capture position of the SEM is moved to an addressing pattern 429 (hereinafter, AP) and imaging is performed. Then, by matching the data (template) for matching in the AP 424, which is previously prepared, and the SEM image, a more accurate stage shift error is calculated. In subsequent image shifts, the field of vision is moved to cancel the calculated stage shift error. Next, in step 410, the image capture position of the SEM is moved to an AF for EP imaging 430 with the image shift and imaging is performed. Then, a parameter of the autofocus adjustment is determined and the autofocus adjustment is performed based on the determined parameter. Next, in step 411, the image capture position of the SEM is moved to an automatic astigmatism correction pattern 431 (hereinafter, AST) with the image shift and imaging is performed. Then, a parameter of the automatic astigmatism correction is determined and the autofocus adjustment is performed based on the determined parameter. The automatic astigmatism correction means that astigmatism is corrected so that the sectional shape of the focused electron ray is like a spot, in order to obtain an image having no distortion in SEM imaging. Next, in step 412, the image capture position of the SEM is moved to an auto brightness and contrast pattern 432 (hereinafter, ABCC) with the image shift and imaging is performed. Then, a parameter of the auto brightness and contrast is determined and the auto brightness and contrast adjustment is performed based on the determined parameter. The auto brightness and contrast means that, in order to obtain a sharp image having an appropriate brightness value and contrast in the EP imaging, a setting is performed so that a full or almost full contrast is formed between the highest part and lowest part of an image signal, by adjusting parameters such as a voltage value of a photomultiplier in the secondary electron detector 209. Because the field of vision is moved to the AF for the AP, and the AP, AF, AST and ABCC for the EP with the image shift, it is required to be set the field of vision in the range 427 in which the image shift can be performed.

After performing the addressing and the image adjustment in step 407, in step 413, the image capture position is moved to the EP with the image shift and imaging is performed.

On completion of imaging of all Nb EPs (step 414), in step 415, the wafer is removed from the SEM device.

Here, the alignment and the image adjustment in steps 404, 405 and 408 to 412 described above may be partly omitted or the order of the steps may be changed, depending on situations.

Here, in view of a problem of sticking (contamination) of contaminants on the sample caused by the electron ray irradiation, the adjustment points (AP, AF, AST, ABCC) are generally set so that the EP and the image capture region do not overlap each other. When one region is imaged two times, phenomena such as a dark image or variations in pattern line width appear more strongly in the second image due to contamination. Therefore, in order to remain the pattern shape accuracy in an EP used for evaluation of the evaluation pattern, various adjustments are performed with patterns around the EP and the EP is imaged with parameters after the adjustments so as to minimize the electron ray irradiation to the EP.

In this way, the image capture sequence includes coordinates of various image capture patterns (EP, AP, AF, AST, ABCC), sizes (field of vision or image capture magnification), image capture order (including means of moving the field of vision to each image capture pattern (stage shift or image shift)), image capture conditions (probe current, acceleration voltage, scanning direction of the electron beam or the like). The image capture sequence is specified by the image capture recipe. The data (template) for matching used for alignment or addressing is also registered in the image capture recipe. Further, the matching algorithms (an image processing image and image processing parameters) in alignment or addressing are also registered in the image capture recipe. The SEM captures images of the EPs based on the image capture recipe.

### 2. Circuit Pattern Imaging and Evaluating Method

### 2.1 Overview

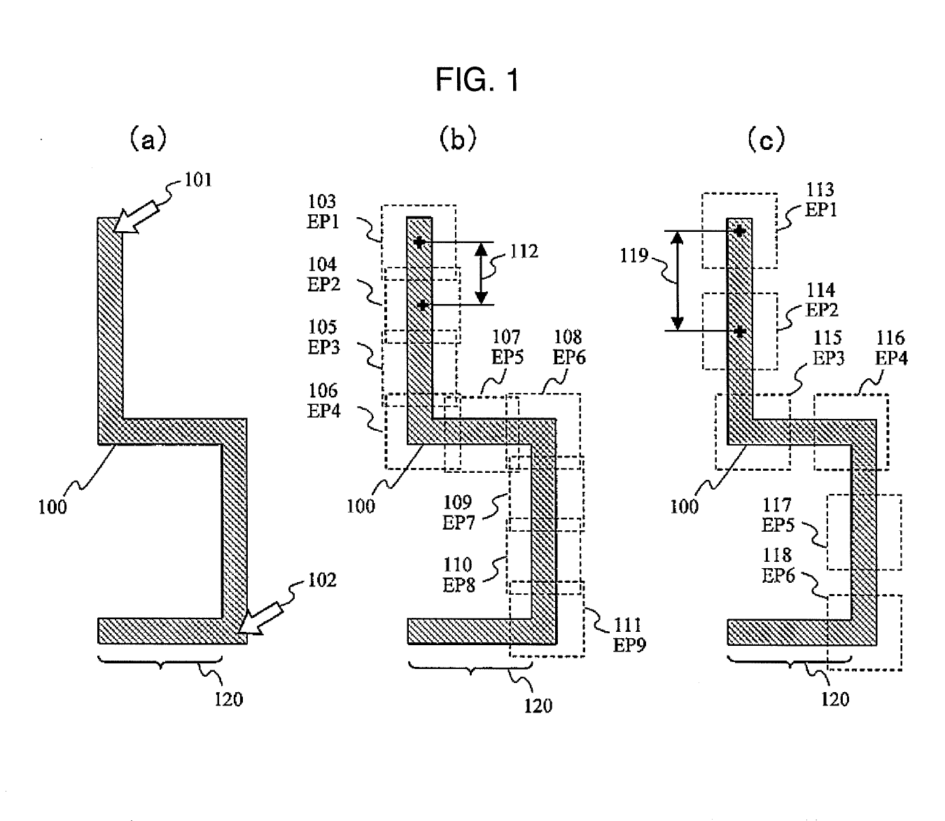

FIG. 1 shows an overview of an imaging method according to the present invention. The present invention is a method for evaluating an evaluation pattern with a group of images obtained by imaging a particular circuit pattern (an evaluation pattern) formed on a semiconductor wafer with a SEM in a plurality of actions while shifting an image capture position, characterized by including: an evaluation pattern determination step of determining the evaluation pattern among the circuit patterns; a permissible distance value specification step of specifying a permissible value of distance (a permissible distance value) between any adjacent first image and second image included in the group of images; an image capture region determination step of determining an image capture region of the group of images so that at least a part of the evaluation pattern is included in the image capture region and the adjacent images satisfy the permissible distance value; and an image capture step of capturing the group of images of the evaluation pattern by imaging the determined image capture region of the group of images.

FIG. 1(a) shows how a circuit pattern 100 (an evaluation pattern) to be evaluated is determined among a plurality of circuit patterns formed on the wafer. Although circuit patterns other than the evaluation pattern are not shown, the circuit patterns are generally present around the evaluation pattern. Patterns selected as the evaluation patterns include (1) a pattern in which electrical failure occurs, which is found by a burn-in test or the like, (2) a pattern in which it is estimated with litho-simulation or the like that a fault is likely to occur, (3) a pattern which is a wiring important to the circuit and whose quality should be particularly carefully inspected, or the like. The evaluation pattern may be automatically determined or specified by a user, based on these criteria. In respect of a way of specifying the evaluation pattern by the user, as shown in FIG. 1(a), a pattern 100 that is desired to be the evaluation pattern is specified with input means such as a mouse, as shown by a mouse cursor 101, for design data or a captured image (an image captured with an optical microscope, or an image captured with a low or high magnification with a SEM) of the circuit pattern displayed on a screen, for example. Also, the evaluation pattern may be not an entire closed figure represented by a pattern contour line, but a part thereof. In other words, an entire pattern may be specified as the evaluation pattern by indicating a part of the pattern that is desired to be the evaluation pattern, or a start point and an end point of a part that is desired to be the evaluation pattern may be specified with mouse cursors 101, 102, respectively, to set the part between the points as the evaluation pattern (in the latter case, only the part of the pattern 100 expect the part 120 will be the evaluation pattern).

In order to efficiently inspect the circuit pattern, the position and shape of the evaluation pattern are recognized by determining the evaluation pattern as described above and images are captured separately several times so that at least a part of the evaluation pattern is included in the field of vision. Here, the images can efficiently captured by setting the permissible distance value between any adjacent first image and second image.

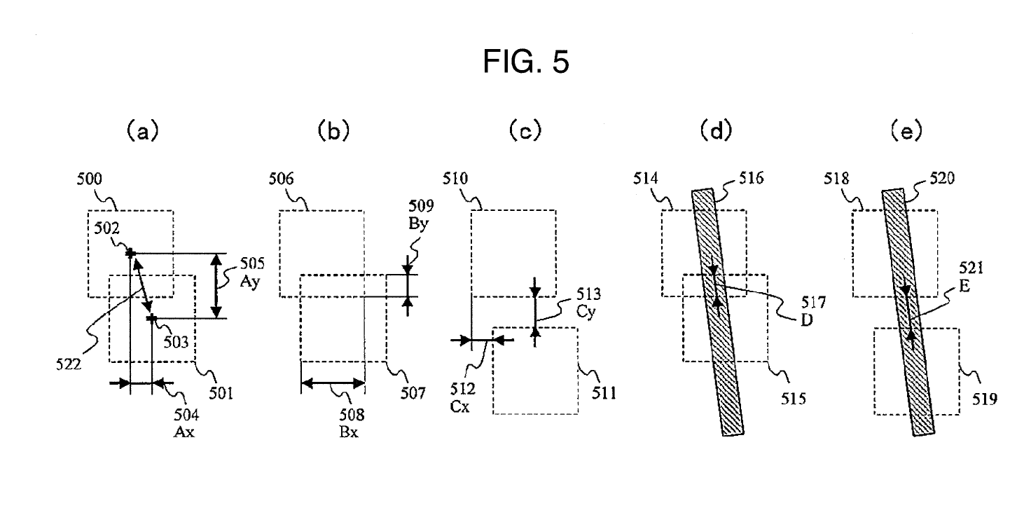

The distance between adjacent images will be described. The distance between images may be a distance between the centers of adjacent images, a distance between the ends of adjacent images, or a length of the evaluation pattern included in an overlap region of the adjacent images or a space between the adjacent images. A plurality of definitions of the distance will be described in reference to FIGS. 5(a) to 5(e).

FIG. 5(a) shows a case where the distance between two EPs 500, 501 is given as the distance between the centers 502, 503 of the respective image capture ranges. Distances Ax, Ay between the centers in the X, Y directions are denoted by reference numerals 504, 505 and the EP is determined so that the distance Ax, Ay, MAX(Ax, Ay), MIN(Ax, Ay), SQRT(Ax̂2+Aŷ2) or the like satisfy the permissible distance value. Here, MAX(a, b), MIN(a, b) are maximum and minimum values of a, b, respectively, and SQRT(a) is a function that returns the square root of a.

FIG. 5(b) shows a case where the distance between the EPs 506, 507 is given as a width of the overlap region of both image capture regions. Widths Bx, By of the overlap region in the X, Y directions are denoted by reference numerals 508, 509, respectively. Although FIG. 5(b) shows a case where two EPs overlap each other, the distance between the EPs 510, 511 may be given as a deviation width between both EPs, if there is no overlap, as shown in FIG. 5(c). Deviation widths Cx, Cy in the X, Y directions are denoted by reference numerals 512, 513, respectively.

FIG. 5(d) shows a case where the distance between the EPs 514, 515 is given as a length D (517) of the evaluation pattern 516 included in the overlap region of both image capture regions. Although FIG. 5(d) shows a case where two EPs overlap each other, the distance between the EPs 518, 519 may be given as a length E (521) of the evaluation pattern 520 included in the space between both image capture regions, if there is no overlap, as shown in FIG. 5(e).

In order to efficiently capture the image of the evaluation pattern, it is effective that the distance as shown in FIGS. 5(a) to (e) satisfies conditions given by the permissible distance value and the evaluation pattern is imaged at a suitable interval. For example, if it is desired to make the EPs closer to each other, it is required to set a small permissible distance value if the distance between the EPs is given as MAX(Ax, Ay) described above (reference numeral 505 in FIG. 5(a)), while it is required to set a large permissible distance value if the distance between the EPs is given as MIN(Bx, By) (reference numeral 509 in FIG. 5(b)). Although any definition of the distance may be used, the meaning of magnitude of the value is varied depending on the definitions. In the following description, the distance between the EPs will be described as the distance between the centers of the images SQRT(Ax̂2+Aŷ2) (reference numeral 522 in FIG. 5(a)). In this distance, the EPs are closer to each other as the value is smaller, while the EPs are further from each other as the value is larger.

The permissible value of the distance between adjacent images (the permissible distance value) will be described. The permissible distance value may be given as one value or as a region (minimum value, maximum value). The permissible distance value is roughly categorized into the following two, depending on a magnitude of the value.

(Condition 1) a permissible distance value in which image capture regions of adjacent first image and second image overlap each other.
(Condition 2) a permissible distance value in which image capture regions of adjacent first image and second image do not overlap each other.

FIG. 1(b) is an example where the EP is determined so that the distance between adjacent images satisfies the permissible distance value in the condition 1, for the evaluation pattern (the part of the pattern 100 expect the part 120). In this figure, nine EPs (referred to as EP1 to EP9, sequentially) shown by dotted frames 103 to 111 are arranged. Coordinates of the EPs and the number of the EPs are determined so that the distance between any adjacent EPs, which is represented by a distance 112 between coordinates of the centers (shown by cross marks) of EP1 (103) and EP2 (104), satisfies the permissible distance value in the condition 1 and there is an overlap region between the adjacent EPs. If the minimum value of the distance between adjacent images is set as the permissible distance value in the case of the condition 1, the adjacent images cannot be closer than the minimum value. Therefore, the length of the evaluation pattern redundantly imaged is restricted to a certain degree and the evaluation pattern can be efficiently imaged. On the other hand, if the maximum value is set, there is at least an overlap region between adjacent images. Therefore, any part of the evaluation pattern is likely to be included in either of the captured images so that inspection omission can be avoided.

FIG. 1(c) shows an example where the EP is determined so that the distance between adjacent images satisfies the permissible distance value in the condition 2, for the evaluation pattern (the part of the pattern 100 expect the part 120). In this figure, six EPs (referred to as EP1 to EP6, sequentially) shown by dotted frames 113 to 118 are arranged. Coordinates of the EPs and the number of the EPs are determined so that the distance between any adjacent EPs, which is represented by a distance 119 between coordinates of the centers (shown by cross marks) of EP1 (113) and EP2 (114), satisfies the permissible distance value in the condition 2 and there is a space between the adjacent EPs. In the case of the condition 2, since there is a space between adjacent images, there is a risk of inspection omission in a part of the evaluation pattern in the space where imaging is not performed. However, by setting the minimum value and maximum value of the distance between adjacent images as the permissible distance value, the evaluation pattern can be sampled and inspected in a constant rate so that there is no non-uniformity of inspection positions and the overall tendency of the quality can be recognized.

In the conditions 1 and 2, either or both of the maximum value and minimum value may be set.

Further, as an embodiment including both conditions 1 and 2, the permissible distance value may be given as a region (minimum value, maximum value) wherein the minimum value is the distance with which adjacent images overlap each other and the maximum value is the distance with which there is a space between the adjacent images.

The positions of a plurality of evaluation points (EPs) are optimized so as to satisfy as much as possible the permissible distance value given in this way and the evaluation pattern can be inspected based on the group of captured images of the EPs.

Variations of determination of the image capture sequence according to the present invention are roughly categorized into the following three modes:

(Mode 1) determining the image capture sequence before imaging, by previously recognizing the position and shape of the evaluation pattern using the design data or the like (referred to as an off-line determination mode).
(Mode 2) determining the image capture sequence based on captured images, in the course of repetition of imaging (referred to as an on-line determination mode).
(Mode 3) using both of the off-line determination mode and the on-line determination mode (referred to as a combined determination mode).

These three modes can be executed by switching among them with a GUI or the like. The details will be described hereinafter, sequentially.

### 2.2 Off-Line Determination Mode of Image Capture Sequence (Mode 1)

### 2.2.1 Evaluation Pattern Determination and Image Capture Sequence Determination

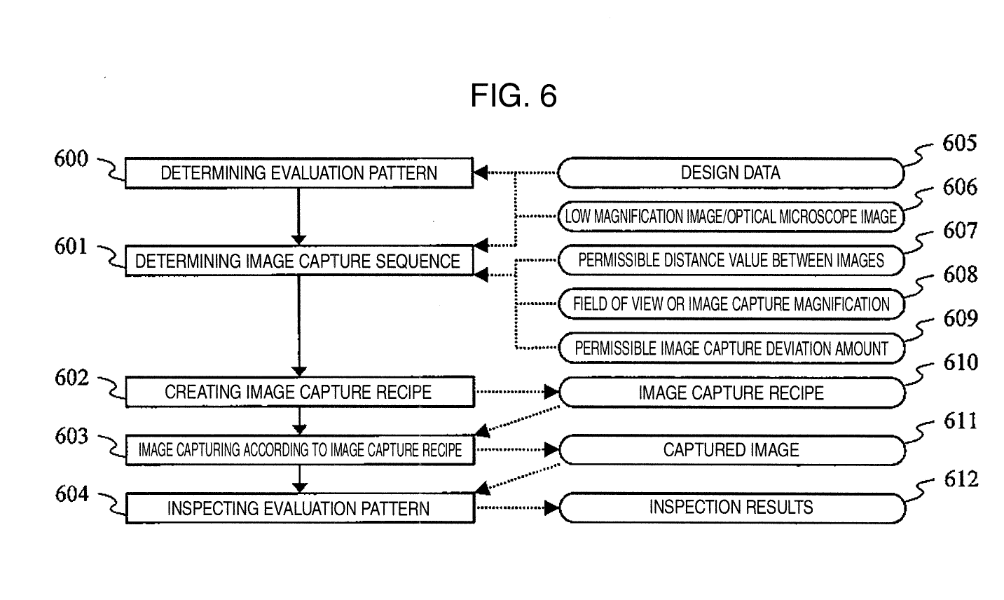

FIG. 6 shows an overall processing flow of the off-line determination mode. Rectangular frames 600 to 604 denote processing contents and frames with rounded corners 605 to 612 denote information used for the processes. Firstly, it is effective to use layout information for the pattern on the wafer, in order to the evaluation pattern. Further, in order to determine the image capture region (EP) so as to include the evaluation pattern, the position and shape of the evaluation pattern have to be recognized. Moreover, in determination of the image capture sequence, it is required to determine a part or all of image capture positions, image capture conditions, an image capture order, various adjustment methods or the like of the EPs and various adjustment points (AP, AF, AST, ABCC), and pattern information around the evaluation pattern is also required. Therefore, evaluation pattern determination (step 600) and image capture sequence determination (step 601) are characterized by being performed based on design data (605) of the circuit pattern including at least the evaluation pattern. As the design data, design data for masking (without/with optical proximity correction (OPC)), design data of a wafer transfer pattern or the like may be used. However, since they may be significantly difference from an actual pattern shape, a simulated shape of the actual pattern estimated from the design data for masking with litho-simulation or the like may be used.

Alternatively, in place of the design data, it is characterized in that steps 600, 601 are performed based on a low magnification image by previously obtaining the low magnification image of a wide region including at least the evaluation pattern with the scanning charged particle microscope or the optical microscope, the low magnification image being captured with a lower magnification than the image capture magnification of the EP (606). In order to avoid inspection omission, a high image resolution is required for the EP image used to inspect the evaluation pattern. On the other hand, when the EP image is used to recognize the evaluation pattern, a certain level of image resolution is sufficient. Further, the low magnification image has generally a wide field of vision and is convenient to recognition of the evaluation pattern.

Although the design data, the low magnification image or both of them may be used in steps 600, 601, a case using the design data will be particularly described in the following description. In step 600, the design data is displayed on a screen and the evaluation pattern can be specified, as shown FIG. 1(a).

In step 601, the image capture sequence is determined with a permissible distance value between adjacent images (EPs) 607, a field of vision or an image capture magnification of the EP 608 and a permissible image capture deviation amount of the EP 609 being as inputs, in addition to the layout information for the pattern obtained from the design data or the like. The field of vision or the image capture magnification of the EP, which is one of the image capture conditions, can be given as a range, such as 1 μm to 2 μm. The image capture sequence is optimized in the computer so as to satisfy constraint conditions for the distance between the EPs, the field of vision of the EP, the permissible image capture deviation amount of the EP or the like and the image capture sequence can be automatically determined.

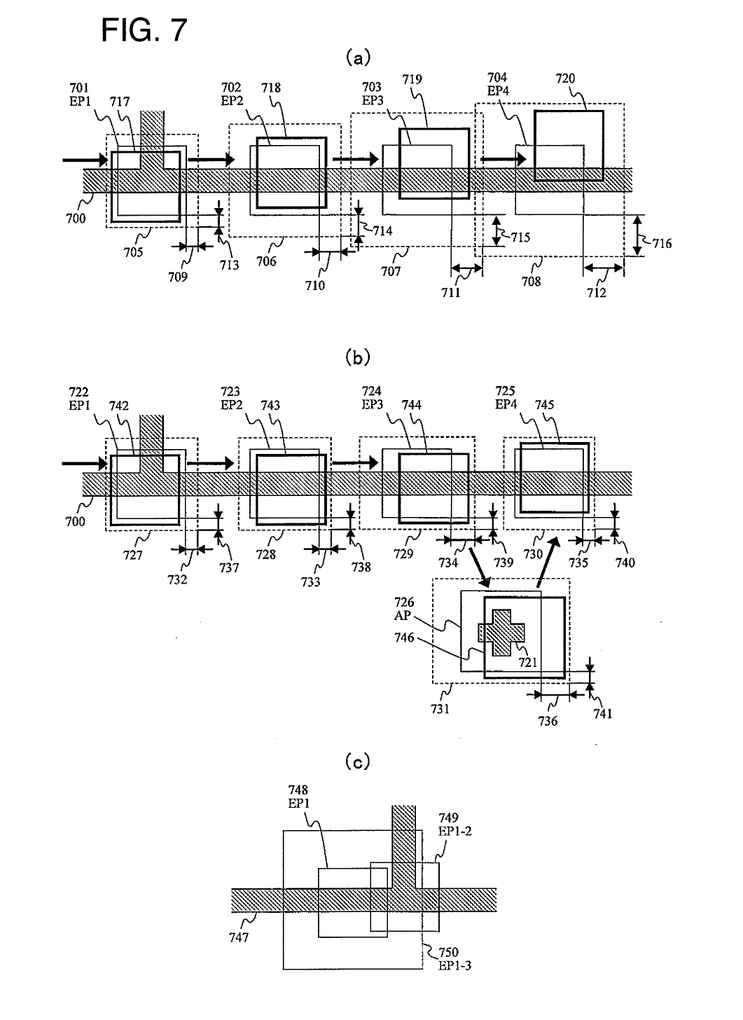

An example of the image capture sequence will be described in reference to FIG. 7. FIG. 7(a) shows an image capture sequence for imaging an evaluation pattern 700, showing an image capture sequence determined in no consideration of the permissible image capture deviation amount and accordingly image capture positions imaged with no addressing. This example shows how four EPs (EP1 to EP4) arranged to satisfy the permissible distance value between certain EPs are imaged in numerical order. Although the image capture position is moved with the stage shift or image shift, both shifts have a limit of positioning accuracy. Therefore, the actual image capture position can deviate from the predetermined image capture positions 701 to 704 of the EP1 to EP4 determined at the time of determination of the image capture sequence, as shown by thick frames 717 to 720, for example. The maximum image capture deviation amount which can occur in each of the stage shift and the image shift can be approximated. Thus, the maximum image capture deviation ranges which can occur in EP1 to EP4 are expected based on means of moving the field of vision to each EP (stage shift, image shift) and they are shown by dotted frames 705 to 708. The maximum image capture deviation amounts Gx from the predetermined image capture positions 701 to 704 in the X direction are denoted by reference numerals 709 to 712, respectively, and the maximum image capture deviation amounts Gy in the Y direction are denoted by reference numerals 713 to 716, respectively. In other words, the actual image capture positions can deviate from the predetermined image capture positions by ±Gx, ±Gy and therefore the actual image capture positions 717 to 720 are fit in the corresponding dotted frames 705 to 708, but it is not known where they are in the frames 705 to 708. The image capture deviations are accumulated with each repetition of moving the field of vision. Therefore, the maximum image capture deviation range increases with the number of EP imaging actions and it is more likely not to satisfy the permissible image capture deviation amount of the EP. The actual image capture position 720 to EP4 is only an example, but it deviates significantly from the predetermined image capture position 704 so that the evaluation pattern cannot be imaged near the center of the image.

Thus, FIG. 7(b) shows an image capture sequence determined in consideration of the permissible image capture deviation amount (609) and image capture positions with addressing in order to capture images of the same evaluation pattern 700. The predetermined image capture positions corresponding to EP1 to EP4 are denoted by reference numerals 722 to 725, the maximum image capture deviation ranges are denoted by reference numerals 727 to 730, the maximum image capture deviation amounts Gx in the X direction are denoted by reference numerals 732 to 735, the maximum image capture deviation amounts Gy in the Y direction are denoted by reference numerals 737 to 740 and the actual image capture positions are denoted by reference numeral 742 to 745. It is conceivable that the addressing point (AP) 429, which is a pattern for positioning, is imaged before imaging of the EPs to correct a position deviation as shown in FIG. 4(b), as a way of reducing the image capture deviation of the EP. However, such an addressing has following problems.

(a) It is required that the AP is previously determined. (b) There is not always an appropriate AP around the EP. (c) Throughput is decreased because it takes a considerable time to capture the image of the AP and estimate the image capture deviation.

Thus, according to the present invention, it is characterized in that the actual image capture position of a m-thly imaged EP among the EP group is estimated based on the m-thly imaged EP and a stage shift amount or image shift amount to the image capture position of an n-thly (n>m) imaged EP is adjusted based on the estimated actual image capture position. In other words, the image capture deviation amount which occurs in the EP is estimated from the EP image and the stage shift amount or image shift amount to the next EP to be imaged is determined to cancel the image capture deviation amount. In this way, the accumulation of the image capture deviation amounts with each repetition of moving the field of vision can be avoided. Further, it is not required to capture the image of the AP or the like only for addressing. The image capture deviation in the EP can be estimated by matching an actually captured EP image and the design data or the low magnification image at the predetermined image capture positions of the EP. Furthermore, if the EP is determined according to an arrangement rule (for example, the evaluation pattern is in the center of the field of vision of the EP image) in determination of the image capture sequence, the image capture deviation can be estimated by recognizing the position of the evaluation pattern in the actually captured EP image and detecting a deviation from the center of the image of the evaluation pattern. In FIG. 7(b), EP1 is initially imaged where the predetermined image capture position is given as a position 722 and an image capture deviation amount which occurs in EP1 is estimated with the EP1 image, according to the above described method. The EP1 image 742 includes a pattern edge varying in both X and Y directions. Therefore, position deviation amounts in both X and Y directions can be estimated. Next, the field of vision is moved to EP2 while canceling the image capture deviation amount of EP1 and imaging is performed. Because the image capture deviation occurs also in movement of the field of vision to EP2, an expected maximum image capture deviation range 728 has a certain width. However, the range 728 is smaller than the maximum image capture deviation range 706 of EP2 in FIG. 7(a) since the image capture deviation in EP1 cannot be accumulated. Similarly, the image capture deviation amount which occurs in EP2 is estimated with the EP2 image. Here, only the position deviation amount in Y direction can be estimated because the EP2 image 743 includes only a pattern edge varying in the Y direction. As a result, the field of vision can be moved to EP3 while canceling only the image capture deviation amount of EP2 in the Y direction and the image capture deviation in the X direction is accumulated so that a maximum image capture deviation range 729 of EP3 is elongated in the X direction (Gx (734)>Gy (739)). The EP3 image 744 also includes only a pattern edge varying in the Y direction. Therefore, the image capture deviation in the X direction is further increased at the time of imaging of the next EP4. If the permissible image capture deviation amount (609) given as the condition and the maximum image capture deviation amount 734 in the X direction in EP3 are close to each other, the requirement cannot be satisfied when the image capture deviation further increases. In such a case, a conventional addressing using the AP can be combined. In other words, after imaging of EP3, a unique pattern, with which a position deviation amount can be estimated, is imaged as an AP to estimate the image capture deviation amount and thereafter the field of vision is moved to EP4 while canceling the image capture deviation amount in the AP. In the example in FIG. 7(b), a pattern 721 is selected as the unique pattern and an AP 726 including the pattern 721 is set. The maximum image capture deviation range 731 of the AP is larger than the maximum image capture deviation range 729 of EP3 due to additional accumulation of the image capture deviation in the X direction. However, even if the image capture position deviates by the maximum image capture deviation amount Gx (736) in the X direction, addressing cannot be unsuccessful because a pattern edge required for alignment is included in the image capture range, for example. The position and size of the AP are also determined so as to realize this. With the addressing in the AP, the maximum image capture deviation range 730 of EP4 becomes small and the permissible image capture deviation amount can be satisfied. As described above, the throughput is decreased more or less by setting the AP in this way, but the number of addressings in the AP can be minimized in combination with estimation of the maximum image capture deviation amount and addressing in the EPs.

The position and size of the EP can be also determined in consideration of such an image capture deviation. FIG. 7(c) shows EP1 (748), which is one EP among the EP group for imaging an evaluation pattern 747 (other EPs are not shown). Although EP1 has been determined in consideration of the shape of the evaluation pattern or permissible distance values to other EPs, alignment in the X direction is difficult because EP1 includes only a pattern edge varying in the Y direction. If the image capture deviation in the X direction which can occur in EP2 (not shown) imaged next to EP1 does not satisfy the permissible image capture deviation amount, it is required to perform addressing in the X direction before imaging of EP2. For this purpose, the following two options can be used, in addition to an option of performing addressing in surrounding patterns, such as the AP 726 in FIG. 7(b). One option is that, if there is a pattern which can be aligned in the X direction in the vicinity of EP1, EP1 is shifted and a region including the pattern which can be aligned is reconfigured as EP1 (referred to as EP1-2 and denoted by reference numeral 749). In this case, in order to satisfy the permissible distance value between the EPs, image capture positions of other EPs may be shifted as required, for example. The other option is that, if there is similarly a pattern which can be aligned in the X direction in the vicinity of EP1 and the field of vision or image capture magnification (608) of the EP, which is one of the image capture conditions, is given as a range such as 1 μm to 2 μm, the field of vision of EP1 is enlarged in the range and a region including the pattern which can be aligned is reconfigured as EP1 (referred to as EP1-3 and denoted by reference numeral 750). In respect of both EP1-2 and EP1-3, it is required to determine the position and size of the EP so that the pattern which can be aligned is fit in the field of vision even with an image capture deviation, in consideration of the maximum image capture deviation ranges in EP1-2, EP1-3.

FIG. 7 shows an example of the image capture sequence. It is characterized in that the image capture deviation in the EP is estimated in this way, the image capture sequence is optimized in a computer so as to satisfy constraint conditions for the distance between the EPs, the field of vision of the EP, the permissible image capture deviation amount of the EP or the like, and the image capture sequence can be automatically determined. This image capture sequence determination includes optimization of an insert timing, the position and size of the AP, or the position and size of the EP. Although not shown in FIG. 7, optimization of insert timing, position, and size of adjustment points (AF, AST, ABCC) other than the AP are also included as required. Further, the maximum image capture deviation amount in each EP in the determined image capture sequence and the degree of satisfaction of the constraint conditions can be presented to the user. Depending on the conditions, there may be theoretically no image capture sequence which satisfies all constraint conditions. Therefore, a GUI is effective that prompts the user to select among a plurality of image capture sequences having a trade-off relationship to each other or to correct the image capture sequence, for example.

### 2.2.2 Image Capturing Recipe Generation, Imaging and Inspection

In step 602 in FIG. 6, it is characterized in that the image capture recipe is created and saved from the image capture sequence determined in step 601 as described above. Once the image capture recipe is created, wafers having the same circuit pattern can be automatically inspected any number of times. Further, by sharing the recipe among a plurality of scanning charged particle microscopes, a plurality of wafers can be inspected in parallel. Furthermore, for similar wafers, an image capture recipe (610) therefor can be created in a short time, by modifying the above described image capture recipe more or less. Moreover, in step 602, a measurement recipe can be created and similarly saved, which specifies image processing algorithms and processing parameters for performing evaluation, such as defect detection, pattern shape measurement and the like in the captured EP images. Although the image capture recipe and the measurement recipe have been separately described in the present specification, setting items in the image capture recipe and the measurement recipe are only examples and each setting item specified in each recipe can be managed in any combination. Further, the image capture recipe and the measurement recipe may be not particularly distinguished from each other, but collectively managed as one recipe.

In step 603, an image is captured according to the image capture recipe (610) to obtain a captured image 611 in the EP. In step 604, inspection results 612 of the evaluation pattern are obtained by processing the captured image based on the measurement recipe. The inspection results include a part or all of a length measurement value of the pattern shape, a pattern contour line, an image characteristic amount for evaluating the pattern, a deformation amount of the pattern shape, for each part of the evaluation pattern. They also includes a normality or abnormality of the pattern shape based on the above described information. Based on these information, the user can monitor determination of defect positions or risk positions in the evaluation pattern or the quality of the evaluation pattern. Here, if imaging of the EP is performed several times, timings of the image capturing in step 603 and the evaluation pattern inspection in step 604 can be arbitrarily changed. In other words, the imaging and the inspection may be alternately performed in such a way that, immediately after imaging EP1, inspection of the evaluation pattern in EP1 is performed and meanwhile the next EP2 is imaged, or inspection of the evaluation patterns in all EPs may be collectively performed after all EPs are imaged.

### 2.2.3 Variation 1: Pattern Branch and Image Capture Range

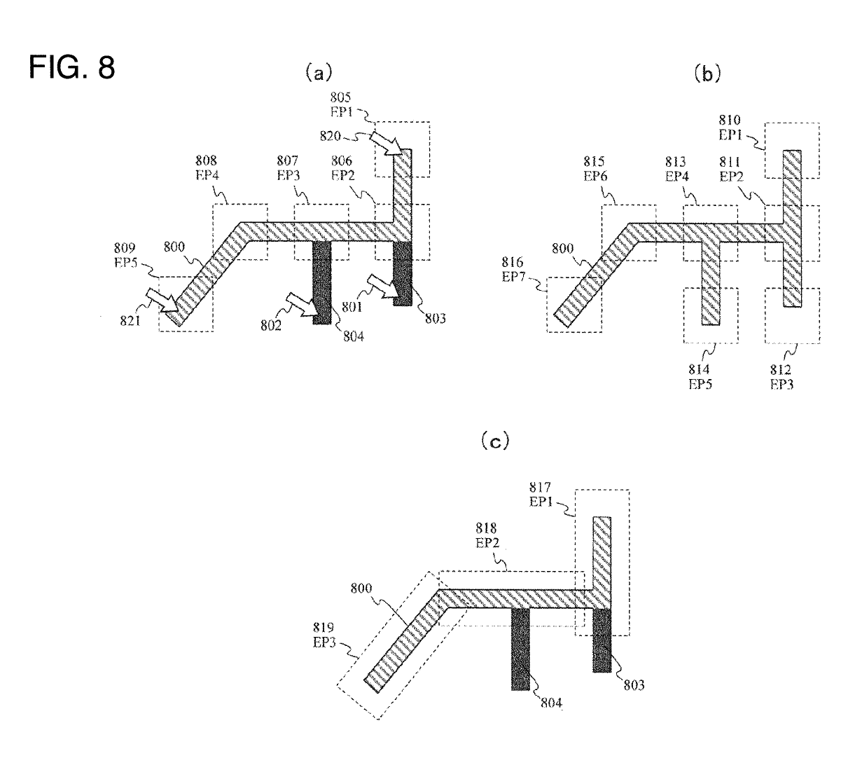

A processing in a case where a pattern is branched will be described in reference to FIG. 8(a). This figure shows an example where a part that is not required to be evaluated is specified among the branched pattern and removed from the evaluation pattern. One way of specifying the part that is not required to be evaluated is that parts 803, 804 (black parts) of a pattern 800, which are desired to be removed from the evaluation pattern, are specified with mouse cursors 801, 802, for example and only a hatched region is set as the evaluation pattern. Alternately, a start point and an end point of an evaluation pattern may be specified with mouse cursors 820, 821, respectively, to set the part between the points as the evaluation pattern. Also in this case, only the hatched region is the evaluation pattern. By setting the permissible distance value so that there is some space between the EPs for the specified evaluation pattern, five EPs (EP1 (805) to EP5 (809)) are arranged, for example.

In comparison to this, FIG. 8(b) shows an embodiment wherein the parts to be removed from the evaluation pattern such as the parts 803, 804 are not specified, but the entire pattern 800 is set as the evaluation pattern. By setting the permissible distance value so that there is some space between the EPs, seven EPs (EP1 (810) to EP7 (816)) including branched patterns are arranged, for example.

Further, a variation of the shape of the EP image capture region is shown in FIG. 8(c). In this figure, the evaluation pattern is a hatched region, as in FIG. 8(a). Some SEMs are equipped with a “Rectangular scan mode”, which elongates a scanning range of an electron beam in an EP to be a rectangular region. The image capture region of the EP has been a square region (for example, the dotted frame 805 in FIG. 8(a)) in the foregoing description, it may be a rectangular region (for example, a dotted frame 817 in FIG. 8(c)). When the permissible distance value is set so that EPs overlap each other to some degree and the EPs are determined with the Rectangular scan mode as the image capture mode of the EPs, three EPs (EP1 (817) to EP3 (819)) are arranged as shown in FIG. 8(c), for example.

### 2.2.4 Variation 2: Tracking of Electrical Path

According to the present invention, it is characterized in that a plurality of patterns that are electrically interconnected to each other are specified based on positions of contact holes and the plurality of patterns are set as the evaluation pattern. For example, it is characterized in that, in determination of a problem position when finding an electrical fault such as a disconnection, not only a circuit pattern represented as one closed figure is inspected as the evaluation pattern, but also patterns that are electrically interconnected to the circuit pattern are included in the evaluation pattern and inspected. Here, it is difficult to determine an electrical interconnecting relationship between two patterns present in respective different layers, for stacked layers of the circuit pattern in the wafer. Thus, the interconnecting relationship is determined based on the positions of the contact holes that interconnect patterns in different layers to each other. The positions of the contact holes can be determined from design data, captured images or the like.

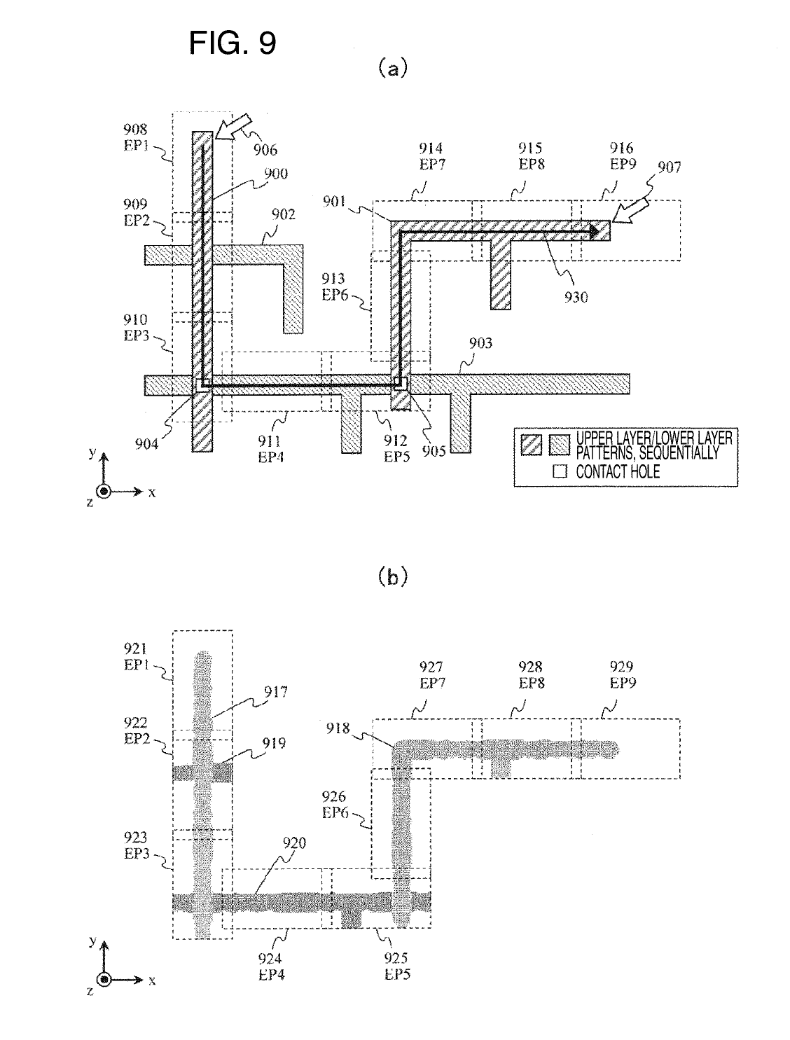

FIG. 9(a) shows a specific example of inspecting an electrical path which bridges two layers (referred to as an upper layer and an lower layer) in stack layers stacked in the Z-axis direction. In this figure, there are two upper layer patterns 900, 901 (shown by patterns hatched from top right to bottom left), two lower layer patterns 902, 903 (shown by patterns hatched from top left to bottom right) and two contact holes 904, 905 (shown by clear squares) electrically interconnecting the upper layers and the lower layers. These representations are performed by drawing the design data, for example. Contrary to this configuration, it is considered to inspect an electrical path between a start point and an end point as the evaluation pattern, wherein the start point and the end point are specified with mouse cursors 906, 907. For example, the upper layer pattern 900 and the lower layer pattern 902 appear to cross each other in the XY plane. However, the layers are insulated and have no electrical interconnection to each other because there is no contact hole. On the other hand, the upper layer pattern 900 and the lower layer pattern 903 are connected via a contact hole 904 and have an electrical interconnection. In view of the above description, the electrical path from the start point 906 to the end point 907 is identified by a thick arrow 930 and the parts of the patterns through which the thick arrow 930 passes are set as the evaluation pattern. When the permissible distance value is set so that EPs overlap each other to some degree and the EPs are determined with the Rectangular scan mode as the image capture mode of the EPs, nine EPs (EP1 (908) to EP3 (916)) for inspecting the evaluation pattern are arranged, for example. FIG. 9(b) shows EP1 to EP9 determined in FIG. 9(a) wherein captured images (sequentially 921 to 929) actually imaged with the SEM are arranged at corresponding positions. For purposes of illustration, the upper layer pattern is shown in light gray and the lower layer pattern is shown in dark gray. Patterns on the captured images corresponding to the patterns 900 to 903 in the design data are denoted by reference numerals 917 to 920, sequentially. The contour of the pattern in the captured image has irregularities or rounded corners due to line edge roughness (LER) or optical proximity effect (OPE) or the like, in comparison to the design data shown in FIG. 9(a). The degree of risk of the pattern in the electrical path can be evaluated by evaluating such a shape in the captured image.

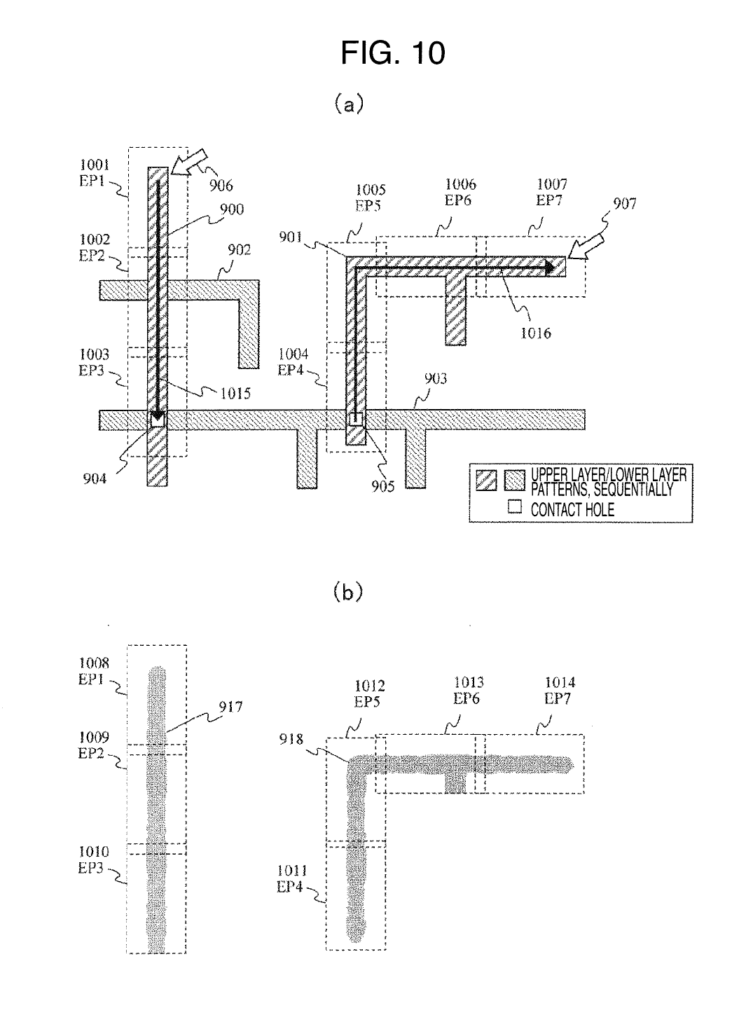

FIG. 9 shows an embodiment in a case where the lower layer pattern can be observed in SEM imaging. However, the lower layer pattern may not be observed in the SEM image depending on film thickness or materials of layers, image capture conditions of the SEM or the like. In this case, only patterns that can be observed in the SEM may be set as the evaluation pattern. An embodiment in such a case is shown in FIG. 10. FIG. 10(a) is an example where a start point 906 and an end point 907 are given for a group of patterns 900 to 903 as in FIG. 9(a) and an electrical path is same as that in FIG. 9(a). However, it is assumed in this example that the lower layer pattern cannot be observed in the SEM image. In this case, only parts of the patterns through which thick arrows 1015, 1016 pass can be set as the evaluation pattern, with the thick arrows 1015 and 1016 indicating electrical paths to be inspected, where a path on the lower layer pattern 903 is removed from the electrical path denoted by reference numeral 930 in FIG. 9(a). Seven EPs (EP1 (1001) to EP7 (1007)) for inspecting the evaluation pattern are arranged, for example. FIG. 10(b) shows EP1 to EP7 determined in FIG. 10(a) wherein captured images (sequentially 1008 to 1014) actually imaged with the SEM are arranged at corresponding positions. Of course, the lower layer pattern cannot be evaluated because the lower layer pattern is not observed in the captured image. On the other hand, the patterns that can be observed with such a means can be evaluated without any omission, and useless image capturing can be omitted in which the pattern to be evaluated is not imaged even if the imaging is performed. It is possible to automatically determine the electrical path and evaluation pattern and EP arrangement with a computer, with the design data and the start and end points being as inputs, as in FIGS. 9 and 10. Further, it may be set by the user whether a pattern in the SEM image can be observed or not or it may be automatically determined from the SEM image. Furthermore, only a start point is specified with the mouse cursor 906 in specification of the evaluation pattern and an electrical path may be tracked. In this case, it can be specified for each branch whether tracking is performed from the contact hole 906 to left or right or to both sides on the lower layer pattern 903, for example.

### 2.2.5 Variation 3: EP Determination in Consideration of Attribute Information

According to the present invention, it is characterized in that an image capture region (EP) is determined in consideration of attribute information in each part of an evaluation pattern. The attribute information means information for determining a priority of inspection, such as a deformation property of pattern. In other words, determination criteria of the EPs include constraint conditions for the position and shape of the evaluation pattern, the distance between the EPs, the field of vision of the EPs, the permissible image capture deviation amounts of the EPs or the like, as described above. However, in addition to these criteria, the attribute information such as the deformation property of pattern can be considered for the evaluation pattern in the EPs. The deformation property of the pattern can be expected with litho-simulation of the shape of the circuit pattern equipped in an EDA (Electronic Design Automation) tool, for example. Further, attribute information about the deformation property of the pattern can be calculated from the pattern shape by introducing knowledge about deformation of the pattern shape, such as “corners of the pattern are in danger of being rounded”, “an isolation pattern is in danger of being thinner”, “a line end is in danger of being retracted”. For example, an EP determination criterion given by the permissible distance value between adjacent EPs that is input in step 607 of FIG. 6 has viewpoints of avoiding redundant imaging with too much overlap, avoiding non-uniformity of image capture points, and the like. On the other hand, an EP determination criterion based on attribute information such as the deformation property of the evaluation pattern described herein has a viewpoint of preferentially imaging a place where a defect is likely to occur. In EP determination, either or both of these criteria may be used.

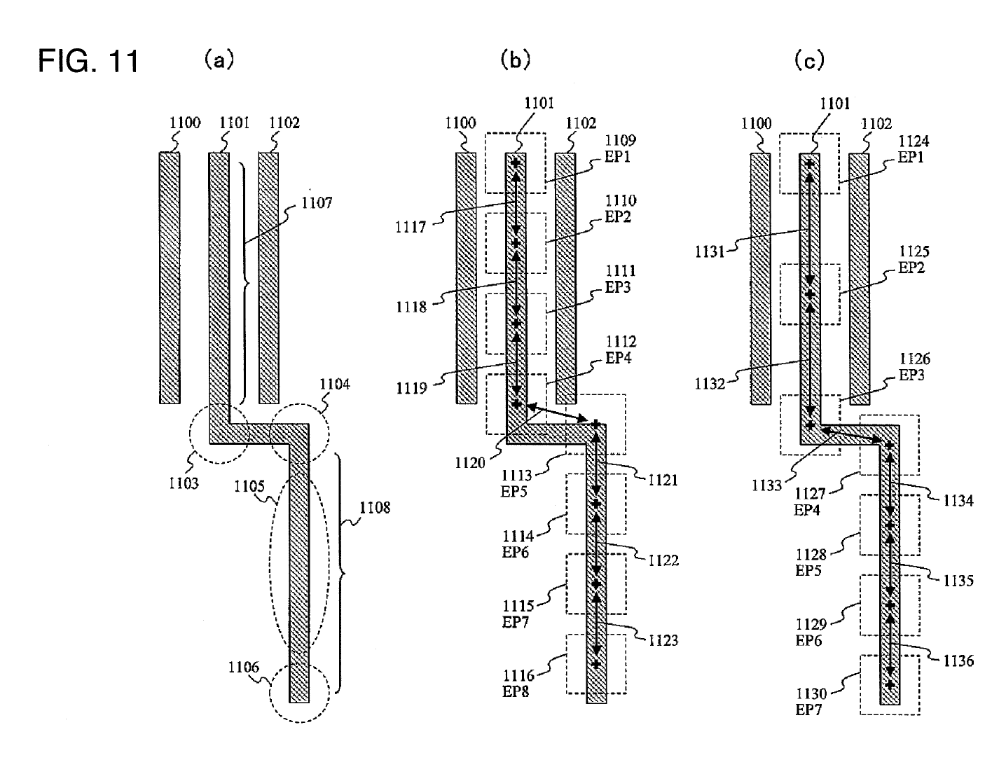

A specific example of determining EPs in consideration of attribute information will be described in reference to FIG. 11. In this figure, three patterns 1100 to 1102 are shown and the evaluation pattern is the pattern 1101. The result of EP determination in consideration of only the permissible distance value between EPs is shown in FIG. 11(b). The permissible distance value is set so that there is some space between the EPs and eight EPs (EP1 (1109) to EP8 (1116)) are arranged. The center of each EP is shown by a cross mark and arrangement of EPs is determined so that distances 1117 to 1123 between the centers of adjacent EPs are close to the permissible distance value.

An example of the above described knowledge about deformation of the pattern shape will now be described for the evaluation pattern 1101 in reference to FIG. 11(a). At corner parts shown by dotted frames 1103, 1104 or the like, deformation of the pattern shape is generally likely to occur. Further, when comparing straight line parts 1107 and 1108 which elongate in a similar way, there is the patterns 1100, 1102 around the straight line part 1107, while the straight line part 1108 is an isolation pattern and it is expected that the line part 1108 is likely to be narrower in the dotted frame 1105 or the like. Furthermore, a line end 1106 can be retracted. The deformation property of the pattern is quantified in this way and calculated as attribute information for each part.

An example of determining EPs in consideration of attribute information will be shown in FIG. 11(c). In this figure, seven EPs (EP1 (1124) to EP7 (1130)) are arranged and spacings 1131, 1132 between EPs are wide in the part 1107 in FIG. 11(a) where the attribute information shows that pattern deformation is relatively not likely to occur. On the other hand, spacings 1133 to 1136 are narrow between EPs in the parts 1103, 1104, 1106, 1108 in FIG. 11(a) where the attribute information shows that pattern deformation is relatively likely to occur. By sampling EPs roughly in a part where the pattern is not likely to deform and densely in a part where the pattern is likely to deform in this way, the inspection efficiency can be enhanced. Further, different permissible distance values can be provided in stages, depending on such attribute information.

### 2.3 Online Determination Mode of Image Capture Sequence (Mode 2)

As an embodiment of a case where information such as the design data cannot be used and the position and shape of the evaluation pattern cannot be previously recognized, it is characterized to estimate a position of the evaluation pattern outside a first image capture region based on a first image obtained by imaging the first image capture region and set a second image capture region so that the estimated evaluation pattern is imaged. In other words, the evaluation pattern included in the captured image is recognized from the image and if it is determined that the evaluation pattern continues to outside the image, a next image capture position is determined so that the evaluation pattern outside the image is included in the field of vision and imaging is performed. By repeating this process, images can be captured while tracking the evaluation pattern. Further, the image capture sequence determined here while imaging can be recorded and saved as the image capture recipe. Such a determination mode of the image capture sequence is referred to as an on-line determination mode.

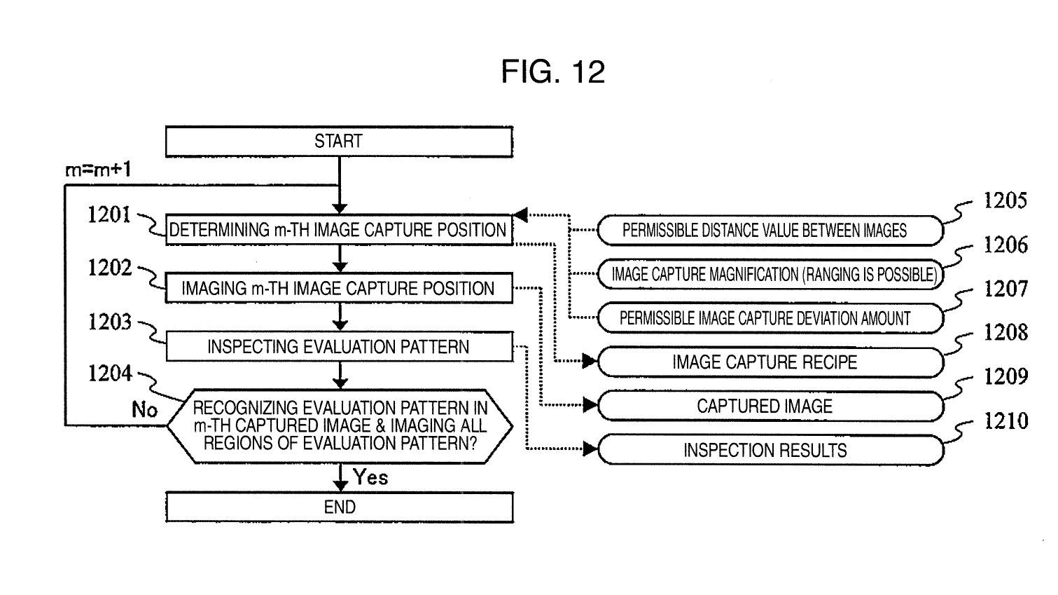

FIG. 12 shows an overall processing flow of the on-line determination mode.

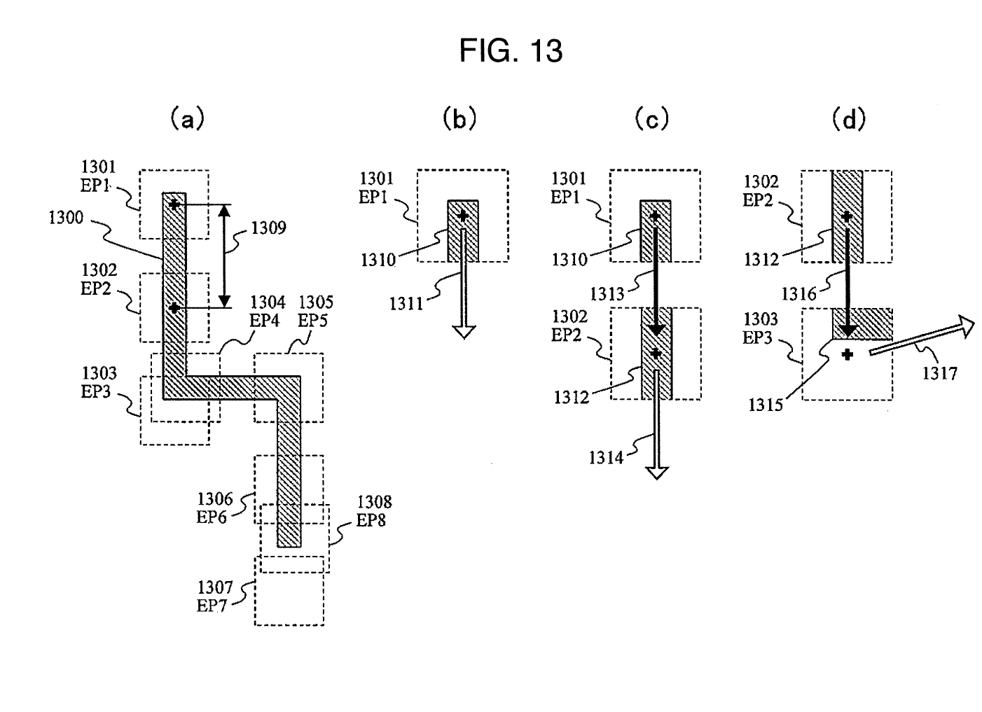

Rectangular frames 1201 to 1204 denote processing contents and frames with rounded corners 1205 to 1210 denote information used for the processes. The on-line determination mode will be described hereinafter in reference to FIGS. 12 and 13. Also in this mode, in a similar manner to the off-line determination mode, the image capture sequence can be determined with a permissible distance value between adjacent images (EPs) 1205, a field of vision or an image capture magnification of the EP 1206, a permissible image capture deviation amount of the EP 1207 being as inputs (these inputs correspond to the inputs 607 to 609 in FIG. 6, respectively). A case where the permissible distance value is 1.5 times of EP size so that there is some space between the EPs will now be described as an example. In the off-line determination mode, the image capture recipe can be prepared by previously determining the image capture sequence from layout information for the pattern obtained from the design data or the like. In the on-line determination mode, the layout information for the pattern is not previously provided. Therefore, the image capture sequence is determined while imaging. The image capture sequence determined here can be saved as an image capture recipe 1208. Firstly, the serial number m of the EP is set to 1 and an image capture position of an image capture start point is determined in step 1201 with m=1 (an EP having m=1 is referred to as EP1).

In step 1202 with m=1, EP1 is imaged. A specific example is shown in FIG. 13. FIG. 13(a) shows an overall evaluation pattern 1300 and FIGS. 13(b) to (d) show captured images of a plurality of EPs wherein the evaluation pattern 1300 is imaged. A pattern among the EP1 images is specified as the evaluation pattern and thereafter images are captured while tracking the evaluation pattern. As a specific example, a pattern 1310 which is a part of the pattern 1300 shown in FIG. 13(a) is imaged in EP1 of FIG. 13(b). After the pattern 1310 is specified as a part of the evaluation pattern, images are captured while tracking the entire evaluation pattern 1300.

In determination of the evaluation pattern, a pattern in the EP1 image may be automatically recognized as the evaluation pattern or the evaluation pattern may be specified by the user among the patterns in the EP1 image. Although there is only one pattern in the EP1 image in this example, one or more pattern may be selected as the evaluation pattern among a plurality of patterns if the plurality of patterns are imaged.

By processing the EP1 image based on a measurement recipe in step 1203 with m=1, inspection results 1210 of the evaluation pattern are obtained (similarly to step 604 and the inspection result 612 in the off-line determination mode). Here, if imaging of the EP is performed several times, timings of the image capturing in step 1202 and the evaluation pattern inspection in step 1203 can be arbitrarily changed, similarly to steps 603, 604 of the off-line determination mode. In other words, inspection of the evaluation pattern in the EP is performed for each EP imaging (an example thereof is shown in FIG. 12), or inspection of the evaluation patterns in all EPs may be collectively performed after all EPs are imaged.

In step 1204 with m=1, the evaluation pattern in the EP1 image is recognized and if it is determined that imaging of all regions of the evaluation pattern is completed, the processing is finished. In the EP1 image 1301 shown in FIG. 13(b), a line end which is a part of the evaluation pattern is imaged near the center of the image capture range and the evaluation pattern reaches the lower end of the image at the bottom of the image capture range. Therefore, it can be expected that the evaluation pattern continues in the direction of an arrow 1311. Then, m is set to 2 (m=2) and the process proceeds to step 1201 again to determine an image capture position of a next EP (EP2). In this case, because it is expected that the evaluation pattern continues in the direction of an arrow 1311, EP2 can be set at a position 1302 ahead of the position 1301 by the permissible distance value 1309 in the direction of the arrow 1311.

Thereafter, steps 1201 to 1204 are repeated until the entire evaluation pattern is imaged at an interval of the permissible distance value.

Now, several examples of a way of determining a (m+1)-th image capture region from a m-th EP will be further described.

A way of estimating EP3 (1303) from EP2 (1302) is shown in FIG. 13, In FIG. 13(c), a pattern 1312 which is a part of the evaluation pattern 1300 is imaged in EP2. Although the evaluation pattern is truncated at the upper and lower ends of the image, it can be expected that the evaluation pattern not yet imaged continues in the direction of an arrow 1314 because a motion vector from EP1 to EP2 is a vector 1313. Therefore, EP3 can be set at a position 1303 ahead of the position 1302 by the permissible distance value in the direction of the arrow 1314. Although EP3 may be successfully set by such an expectation of the evaluation pattern shape from the already imaged EP1 and EP2, the shape of the evaluation pattern not yet imaged is unknown anyway and the image capture position of EP3 may be not optimal. FIG. 13(d) shows an example thereof. In the EP3 image 1303, the evaluation pattern 1315 is located at the end of the image and it is difficult to evaluate the evaluation pattern shape such as a line width. Further, estimation of the direction in which the evaluation pattern continues is more or less difficult. In this case, an image capture position slightly shifted from EP3 may be imaged as EP4, in the vicinity of EP3, or imaging may be continued by estimating the direction in which the evaluation pattern would continue from EP3 to the extent possible. In the former case, it is estimated that the image capture position of EP3 is slightly too low and the pattern appears to continue to the right side, from the evaluation pattern 1315 imaged in the EP3 image. Therefore, imaging is then performed with an image capture position 1304 being set as EP4 as shown in FIG. 13(a), for example. In this case, the permissible distance value between EPs can be exceptionally overridden or changed. The image capture position of EP5 is set at a position 1305 because it is estimated that the evaluation pattern continues to the right side, from the evaluation pattern imaged in EP4. In the latter case, because it is estimated from the evaluation pattern 1315 imaged in the EP3 image that it is better to shift the image capture range slightly upward in order to capture the evaluation pattern in the center of the image and the pattern appears to continue to the right side, a position 1305 ahead of the position 1303 by the permissible distance value in the direction of the arrow 1317 of FIG. 13(d) is set as EP4 (although the position 1305 is indicated as EP5 in FIG. 13(a), the position 1305 is EP4 in this embodiment because the position 1304 is not imaged).

The image capture sequence after EP7 (1307) will be described in FIG. 13. Although it is estimated that the evaluation pattern would continue downward from EP6 and EP7 has been imaged, the actual evaluation pattern has a line end between EP6 and EP7 so that the evaluation pattern is not image in EP7. In this case, the processing may be finished under the determination that imaging of the entire evaluation pattern is completed at the time of imaging EP7 (the determination in step 204 is “Yes”) or imaging may be continued by setting EP8 (1308) between EP6 and EP7, for example. In the latter case, there are two aims. One aim is to avoid a failure in tracking the evaluation pattern. If the evaluation pattern bends to the right between EP6 and EP7 and continues further, tracking of the evaluation pattern is interrupted on its way. The other aim is to avoid skipping evaluation of the shape of a line end which is generally likely to deform, even if the evaluation pattern has a line end between EP6 and EP7 (an example thereof is shown in FIG. 13).

Here, the following processes (A) to (D) can be performed also in the on-line determination mode, in the same manner as in the off-line determination mode.

(A) As shown in FIG. 7, addressing in an EP (estimation of an image capture deviation in an EP, approximation of the maximum image capture deviation amount in a next EP, determination of the amount of movement of the field of vision to the next EP while canceling the image capture deviation amount) can be performed. In the case of the on-line determination mode, the image capture deviation can be estimated according to a rule in which there is no image capture deviation if the evaluation pattern is in the center of the field of vision of the EP image, for example. Further, adjustment points (AP, AF, AST, ABCC) may be inserted in the course of the image capture sequence, as required. For example, an AP is inserted if the image capture deviation cannot be lower than the permissible image capture deviation amount only with addressing in EP. The position of the AP may be selected from surrounding patterns imaged in the EP image, or the AP may be selected from a pattern included in an image obtained by image capturing around the evaluation pattern with a low magnification at a time when it is required to search a suitable AP, in the course of the sequence.

(B) If the evaluation pattern is branched in the imaged EP, a pattern to be tracked may be selectively specified as shown in FIG. 8(a) or all patterns may be tracked as shown in FIG. 8(b).

(C) As shown in FIG. 9, if an electrical path bridges stacked layers and patterns can be observed in the SEM image, the electrical path bridging stacked layers may be tracked.

(D) As shown in FIG. 11, attribute information for the pattern is calculated from the captured image and the next EP image capture position may be controlled based on the attribute information.

### 2.4 Combined Determination Mode of Image Capture Sequence (Mode 3)

An embodiment using both the off-line determination mode and the on-line determination mode will be described. Such a determination mode of the image capture sequence is referred to as a combined determination mode. In this mode, firstly, the image capture sequence is determined off-line with layout information for the pattern obtained from the design data or the like according to the off-line determination mode. However, the design data or the like can be different from the actual pattern shape so that the off-line determination may be not always successful. In order to determine a correct image capture sequence in consideration of such a difference in shape, a simulated shape of the actual pattern estimated with litho-simulation or the like from the design data may be used as the layout information, but the precision of the estimation may not yet be sufficient. Thus, imaging is performed according to the image capture sequence that is determined off-line and the image capture sequence is examined based on the currently captured image and changed as required.

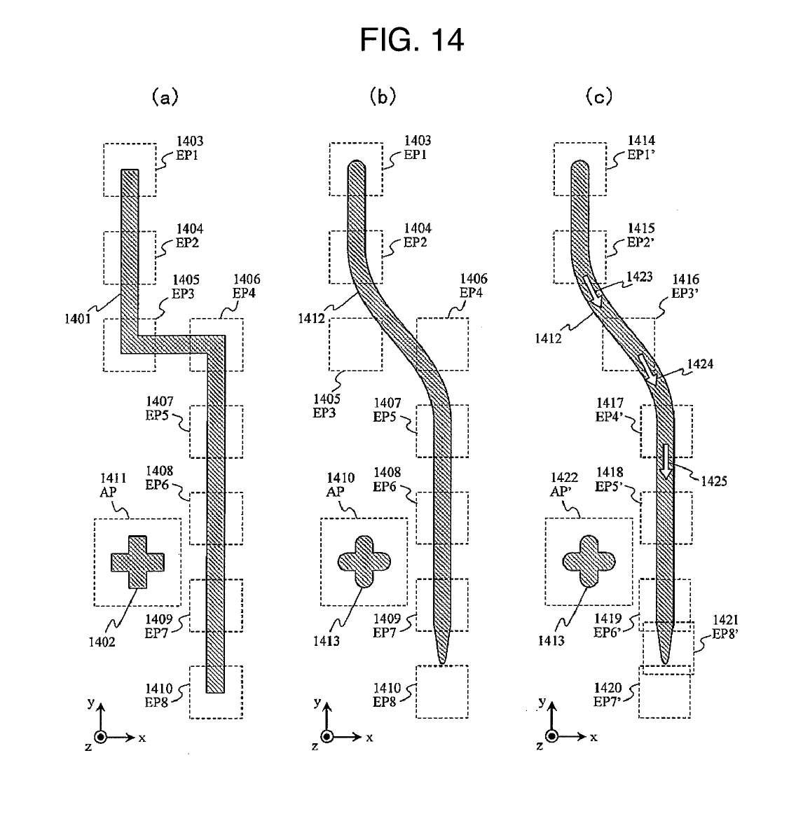

A specific example will be described in reference to FIG. 14. FIG. 14(a) shows an image capture sequence that is determined with the off-line determination mode based on the layout information for the pattern obtained from the design data or the like, for the evaluation pattern 1401. Patterns 1401, 1402 represent design data, and eight EPs (EP1 (1403) to EP8 (1410)) and one AP (1411) are arranged in this figure. In the image capture sequence, EP1 to EP6 are sequentially imaged while performing addressing in the EPs. Next, after addressing in the AP 1411, EP7 and EP8 are imaged. This is because addressing in the Y direction is difficult in EP5 and EP6 and it is expected that the image capture deviation in the Y direction is accumulated to be large in EP7 if addressing in the AP 1411 is not performed. For example, it cannot be known in the on-line determination mode that there is the pattern 1402 around the evaluation pattern, so long as that surrounding patterns are not separately imaged. Therefore, the determination of the image capture sequence with the off-line determination mode is effective in the case where the layout information is previously provided. Thus, the image capture sequence determined with the off-line determination mode is set as an initial value, also in the combined determination mode. In FIG. 14(b), the image capture positions determined with the off-line determination mode are shown overlapped on patterns 1412, 1413 formed on the actual wafer. The actual patterns 1412, 1413 in FIG. 14(b) correspond to the patterns 1401, 1402 in the design data in FIG. 14(a), respectively. However, the patterns 1401, 1402 are only design data and they are different from the actual patterns 1412, 1413 in shape. Therefore, the evaluation pattern 1412 cannot be successfully fit in the field of vision in EP3 (1405), EP4 (1406) and EP8 (1410). In order to solve such a problem, in the combined determination mode, the image capture sequence from the off-line determination mode is modified on-line based on the captured images. An example of the image capture sequence in the combined determination mode is shown in FIG. 14 (c). In this figure, eight EPs (EP1′ (1414) to EP8′ (1421)) and one AP′ (1422) are arranged and addressing in the AP′ is performed between EP5′ and EP6′. Firstly, EP1′ (1414) and EP2′ (1415) which are at the same image capture positions as EP1 (1403) and EP2 (1404) are sequentially imaged. From the captured image of EP2′ (1415), it can be seen that the pattern 1412 bends to the right at the bottom of the image and the pattern shape begins to deviate from the design data. Therefore, it is estimated that the direction in which the pattern continues from the EP2′ image is the direction of an arrow 1423, and the next EP is changed from EP3 (1405), which is determined with the off-line determination mode, to EP3′ (1416). Similarly, it is estimated that the direction in which the pattern continues from the EP3′ image is the direction of an arrow 1424, and the next EP is set to EP4′ (1417). The image capture position of EP4′ (1417) is same as EP5 (1407) which is determined with the off-line determination mode and it is estimated that the direction in which the pattern continues from the EP4′ image is the direction of an arrow 1425 as in the design data. Therefore, the next EP, that is, EP5′ (1418) is the same as EP6 (1408). Thereafter, AP′ (1422), EP6′ (1419), EP7 (1420) are sequentially imaged. However, because the evaluation pattern is not imaged in the EP7′ image, the image capture position may be slightly shifted back to the EP6′ side and EP8′ (1421) may be imaged.

### 3. System Configuration

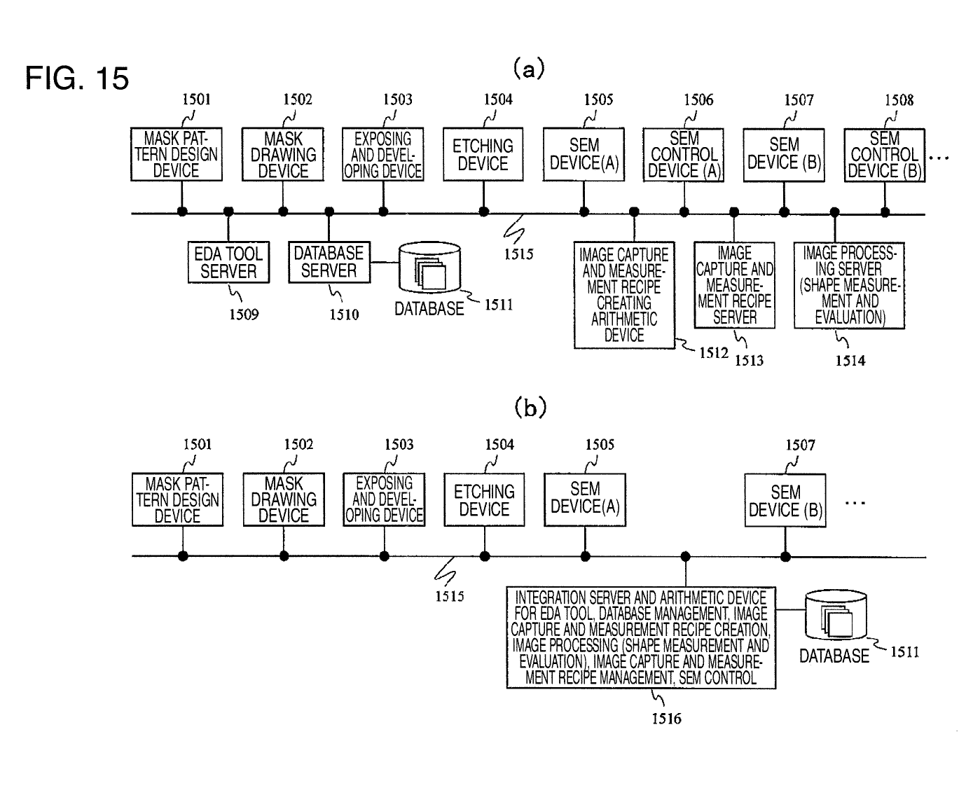

The embodiment of a system configuration according to the present invention will be described in reference to FIG. 15.

In FIG. 15(a), reference numeral 1501 denotes a mask pattern design device, reference numeral 1502 denotes a mask drawing device, reference numeral 1503 denotes an device for exposing and developing a mask pattern onto a wafer, reference numeral 1504 denotes an etching device for a wafer, reference numerals 1505 and 1507 denote SEM devices, reference numerals 1506 and 1508 denote SEM control devices for controlling the SEM devices, respectively, reference numeral 1509 denotes an EDA (Electronic Design Automation) tool server, reference numeral 1510 denotes a database server, reference numeral 1511 denotes a storage for saving a database, reference numeral 1512 denotes an image capture and measurement recipe creating device, reference numeral 1513 denotes an image capture and measurement recipe server, and reference numeral 1514 denotes an image processing server of an image processing device for measuring and evaluating the pattern shape. These components can transmit/receive information via a network 1515. The storage 1511 is attached to the database server 1510 in order to save and share a part or all of (a) design data (design data for masking (without/with optical proximity correction (OPC)), design data of a wafer transfer pattern), (b) simulated shapes of actual patterns estimated from the design data for masking with litho-simulation or the like, (c) generated image capture and measurement recipes, (d) captured images (OM images, SEM images), (e) imaging and inspection results (a length measurement value of the pattern shape, a pattern contour line, an image characteristic amount for evaluating the pattern, a deformation amount of the pattern shape, a normality or abnormality of the pattern shape and the like, for each part of the evaluation pattern), (f) determination rules for the image capture and measurement recipes, linked with product types, manufacturing processes, date and time, data acquisition devices or the like. Further, although two SEM devices 1505, 1507 are connected to the network in this figure as an example, it is possible in the present invention to share the image capture and measurement recipes among any number of SEM devices with the database server 1511 or the image capture and measurement recipe server 1513 and the plurality of SEM devices can be activated with one creation process of the image capture and measurement recipes. Additionally, by sharing the database among a plurality of SEM devices, successful or failed results and causes of failures in the past imaging or measurement are more rapidly accumulated and a reference to this information helps better image capture and measurement recipe generation.

FIG. 15(b) shows how the components 1506, 1508, 1509, 1510 and 1512 to 1514 in FIG. 15(a) are integrated into one device 1516, as an example. As in this example, any function can be separately processed in any plurality of devices or integrally performed.

### 4. GUI

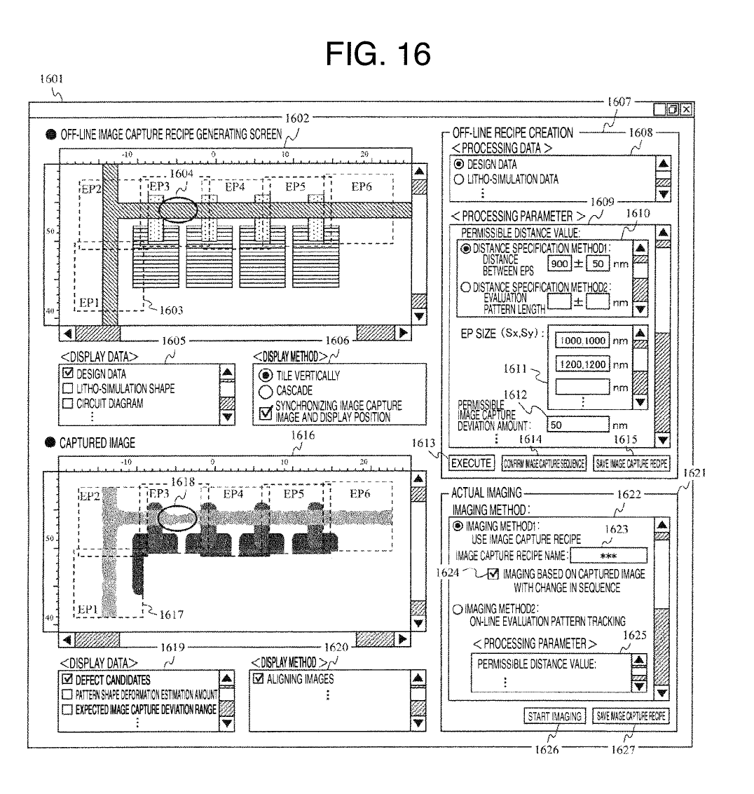

An example of a GUI for inputting various information, setting or displaying image capture recipe generation and output, and controlling the SEM device in the present invention is shown in FIG. 16. Various information drawn in a window 1601 in FIG. 16 can be displayed on a display or the like, in one screen or separately.

The window 1602 is a display for creating and confirming the image capture sequence. By selection with check boxes in a window 1605, design data, simulated shape of an actual pattern estimated from the design data with litho-simulation or the like, a circuit diagram or the like can be displayed in an overlapped manner. In this example in the figure, the design data is displayed. The user can specify an evaluation pattern on the window 1602 with a mouse, a keyboard or the like. Additionally, the image capture sequence determined with the off-line determination mode, the on-line determination mode and the combined determination mode described hereinafter can be displayed.

A window 1607 is a setting screen for determining the image capture sequence with the off-line determination mode. In determination of the image capture sequence, the layout information for the evaluation pattern or its surrounding patterns is required. Therefore, information used as the layout information is specified in a window 1608. Options include design data or litho-simulation data, a low magnification image with a SEM or an optical microscope, etc. A window 1609 is a screen of specifying processing parameters for determining the image capture sequence. A permissible distance value, an EP size and a permissible image capture deviation, which are examples of the processing parameters, are specified in steps 1610, 1611 and 1612, respectively. Because there are a plurality of definitions of the distance between EPs as described in FIG. 5, a desired definition can be selected among the plurality of definitions as a method for specifying the distance, for the permissible distance value. Further, a plurality of options can be provided for the EP size. The EP size may be also given as an image capture magnification. After setting such processing parameters, the image capture sequence can be automatically created in the computer by pressing a button 1613. Furthermore, the created image capture recipe can be displayed in the window 1602 by pressing a button 1614 so that the user can modify the image capture sequence on the screen, as required. EPs (for example, EP1 (1603)) and adjustment points (not shown in figures; AP, AF, AST, ABCC, etc.) can be displayed in the window 1602, overlapped on the layout information. Further, by checking a check box “expected image capture deviation range” in a window 1619, the maximum image capture deviation ranges (the dotted frame 705 in FIG. 7, for example) expected in the EPs and adjustment points can be displayed (not shown). Once determining the image capture sequence, information about the image capture sequence can be saved as the image capture recipe by pressing a button 1615.

A window 1621 is a screen for setting a method for imaging with a SEM. Image capturing can be performed based on an image capture recipe by selecting an “imaging method 1” with a radio button of an imaging method window 1622 and specifying the image capture recipe with a box 1623. If the image capture recipe created by pressing the button 1615 in the box 1623 is specified, images can be captured in the image capture sequence according to the off-line determination mode. Further, by checking a check box 1624, images can be captured with the combined determination mode of the image capture sequence described in FIG. 14(c). Furthermore, by selecting an “imaging method 2” with a radio button of an imaging method window 1622, images can be captured with the on-line determination mode of the image capture sequence described in FIG. 13. The processing parameters in this case can be specified in a window 1625 (setting items in the window 1625 are similar to the setting items in the window 1609). Image capturing is started by pressing a button 1626 after specifying the imaging method, and the image capture sequence in the actual imaging with the SEM can be saved as the image capture recipe by pressing a button 1627.

A window 1616 is a screen for displaying captured images and can display the captured image of the EP group (for example, EP1 (1617)). The images of the adjustments point can be also displayed (not shown). By checking an item “performing alignment between images”, which is one of the items in a window 1620 for specifying the display method, the group of the EP images can be displayed so that the images are connected to each other with overlap regions. Although the layout information such as the design data and the captured images are displayed vertically in other respective windows 1602, 1616 in the display example in this figure, both windows may be also cascaded by switching from a radio box “tile vertically” to a radio box “cascade” in the window 1606 for specifying the display method. By cascading the windows, the difference in shape between the design data and the actual pattern can be clearly visualized, for example. Further, if the windows 1602, 1616 are “tiled vertically” as shown in the display example in this figure, when a vertical or horizontal scroll bar in one window 1602 or 1616 is moved, a scroll bar in the other window is also synchronously moved so that a corresponding image can be displayed, by checking a check box “synchronize captured image and display position” in the window 1606. Furthermore, in imaging with the on-line determination mode, captured images can be serially displayed in the window 1621 to accept designation of an evaluation pattern, designation of a tracked pattern in imaging of a branched pattern, designation of an image capture sequence including image capture regions of EPs or the like from the user, as required and they can be reflected in imaging.

Further, by checking a check box “defect candidate” in the window 1619, defect points or possible defect points in the evaluation pattern can be displayed, as shown in the frames 1604 or 1618. This is based on pattern evaluation results according to the measurement recipe. The evaluation pattern in the frame 1618 is significantly thin in comparison to the evaluation pattern in the frame 1604, which indicates the user that a defect is likely to occur. Further, by checking a check box “pattern shape deformation estimation amount” in the window 1619, a vector indicating a difference from the design data at each point on the contour line of the evaluation pattern can be calculated and displayed.

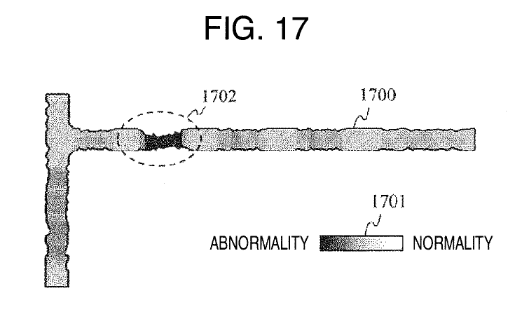

A display variation of the pattern shape evaluation result in the window 1616 is shown in FIG. 17. A normality or abnormality of the pattern shape can be calculated based on a length measurement value of the pattern shape, a pattern contour line, an image characteristic amount for evaluating the pattern, a deformation amount of the pattern shape or the like for each part of the evaluation pattern and can be displayed in a gray scale or in numerical values. FIG. 17 shows an example where the evaluation result for each part of the evaluation pattern 1700 is displayed in the former manner, i.e. in color gradation, and it is brighter as the normality of the pattern shape is higher, while it is darker as the abnormality is higher, as shown by a gauge 1701. In particular, the part surrounded by the dotted frame 1702 is dark, which indicates that the pattern is thin and the degree of risk is high.

With the forgoing measure, the present invention can effectively inspect a disconnection or a shape defect in the circuit pattern, which can cause electrical fault, with an image capturing device. As a result, determination of a cause of a fault found in an electrical test or the like, or determination of a part affecting a process window due to deformation of the pattern shape or the like, even if an electrical fault does not occur, can be quickly performed. Further, the image capture recipe for this inspection can be automatically and rapidly created and reduction in inspection preparation time (recipe creation time) and obviation of operator skills can be expected.

Thus, the present invention is characterized by the following contents, as described above.

(1) A method for evaluating an evaluation pattern with a group of images obtained by imaging a particular circuit pattern (an evaluation pattern) formed on a semiconductor wafer with a SEM in a plurality of actions while shifting an image capture position is characterized by including: an evaluation pattern determination step of determining the evaluation pattern among the circuit patterns; a permissible distance value specification step of specifying a permissible value of distance (a permissible distance value) between any adjacent first image and second image included in the group of images; an image capture region determination step of determining an image capture region of the group of images so that at least a part of the evaluation pattern is included in the image capture region and the adjacent images satisfy the permissible distance value; and an image capture step of capturing the group of images of the evaluation pattern by imaging the determined image capture region of the group of images. Supplemental explanation about this characterization will be described. In order to efficiently inspect the circuit pattern, not only the field of vision is enlarged, but the circuit pattern to be inspected is specified as an evaluation pattern and images are captured separately several times so that at least a part of the evaluation pattern is included in the field of vision. Here, the images can efficiently captured by setting the permissible distance value between any adjacent first image and second image.

The permissible distance value may be given as one value or as a region (minimum value, maximum value). Further, the permissible distance value is roughly categorized into the following two, depending on a magnitude of the value:

(a) a permissible distance value in which image capture regions of adjacent first image and second image overlap each other, and
(b) a permissible distance value in which image capture regions of adjacent first image and second image do not overlap each other.

The distance between images may be a distance between the centers of adjacent images, a distance between the ends of adjacent images, or a length of the evaluation pattern included in an overlap region of the adjacent images (in the case of (a)) or a space between the adjacent images (in the case of (b)), for example. Although either of the definitions of the distance between adjacent images may be employed, a case where the distance between the centers of the images is given will be described in the following description.

Firstly, if the minimum value of the distance between adjacent images is set as the permissible distance value in the case of (a), the adjacent images cannot be closer than the minimum value. Therefore, the length of the evaluation pattern redundantly imaged is restricted to a certain degree and the evaluation pattern can be efficiently imaged. On the other hand, if the maximum value is set, there is at least an overlap region between adjacent images. Therefore, any part of the evaluation pattern is likely to be included in either of the captured images so that inspection omission can be avoided.

In the case of (b), since there is a space between adjacent images, there is a risk of inspection omission in a part of the evaluation pattern in the space where imaging is not performed. However, by setting the minimum value and maximum value of the distance between adjacent images as the permissible distance value, the evaluation pattern can be sampled and inspected in a constant rate so that there is no non-uniformity of inspection positions and the overall tendency of the quality can be recognized.

In (a) and (b), either or both of the maximum value and minimum value may be set.

Further, as an embodiment including both (a) and (b), the permissible distance value may be given as a region (minimum value, maximum value) wherein the minimum value is the distance with which adjacent images overlap each other and the maximum value is the distance with which there is a space between the adjacent images.

The positions of a plurality of evaluation points (EP) are optimized so as to satisfy as much as possible the permissible distance value given in this way and the evaluation pattern can be inspected based on the group of captured images of the EPs.

(2) In the image capture region determination step described in the item (1), it is characterized in that the image capture region of the evaluation pattern is determined based on the design data of the circuit pattern having at least the evaluation pattern.

In order to determine the image capture region (EP) so as to include the evaluation pattern, the position and shape of the evaluation pattern have to be recognized, firstly. As an embodiment for this purpose, the evaluation pattern is recognized using design data, which is layout information for the circuit pattern formed on the wafer. Further, it is characterized in that the image capture sequence is determined by using the design data. The image capture sequence includes at least the above described image capture positions of the EPs and, besides these, a part or all of image capture positions, image capture conditions, an image capture order, various adjustment methods or the like of the EPs and various adjustment points (AP, AF, AST, ABCC).

(3) In the image capture region determination step described in the item (1), it is characterized to previously obtain the low magnification image of a wide region including at least the evaluation pattern with the scanning charged particle microscope or the optical microscope, the low magnification image being captured with a lower magnification than the image capture magnification in the imaging step described in the item (1) and determine the image capture region of the evaluation pattern based on the low magnification image. Similarly to (2), the low magnification image is used as an embodiment of recognizing the position and shape of the evaluation pattern. In order to avoid inspection omission, a high image resolution is required for the image used to inspect the evaluation pattern. On the other hand, when the image is used to recognize the evaluation pattern, a certain level of image resolution is sufficient. Further, the low magnification image has generally a wide field of vision and is convenient to recognition of the evaluation pattern. Further, it is characterized in that the image capture sequence is determined by using the low magnification image, in a similar manner to (2).

(4) In the imaging step described in the item (1), it is characterized in that the actual image capture position of a m-thly imaged image among the image group is estimated based on the m-thly imaged image and a stage shift amount or image shift amount to the image capture position of an n-thly (n>m) imaged image is adjusted based on the estimated actual image capture position.

Measures of changing the image capture position to any EP in the scanning charged particle microscope include a stage shift which changes irradiation positions of charged particles by moving a stage on which a wafer is mounted, and an image shift which changes irradiation positions of charged particles by changing the trajectory of the charged particles by a deflector. Both shifts have a limit of positioning accuracy so that an image capture deviation occurs. Generally, in order to reduce the image capture deviation in the EP, it is required to initially capture an image of a pattern for positioning whose coordinates and a template are provided, referred to as an addressing point (AP), in order to estimate a position deviation amount. However, such an addressing has the following problems. (a) It is required that the AP is previously determined. (b) There is not always an appropriate AP around the EP. The suitable AP means an AP having a unique pattern shape in order to estimate the image capture deviation. Further, in order to reduce sample damage by irradiation of the charged particles, it is generally required that the AP is selected from the region not overlapping the EP. (c) Throughput is decreased because it takes a considerable time to capture the image of the AP and estimate the image capture deviation. In particular, the number of AP imaging actions is large because a plurality of EPs are imaged in the present invention. In order to solve this problem, AP imaging is obviated or the number of AP imaging actions is reduced through the use of imaging of a plurality of EPs in the present invention. In other words, the image capture deviation amount which occurs in the EP is estimated from the EP image and the stage shift amount or image shift amount to the next EP to be imaged is determined to cancel the image capture deviation amount. In this way, the accumulation of the image capture deviation amounts with each repetition of moving the field of vision can be avoided. Further, it is not required to capture the image of the AP or the like only for addressing.

(5) In the image capture region determination step described in the item (1), it is characterized in that the image capture sequence for imaging the image capture region with the scanning charged particle microscope is determined and saved as the image capture recipe.

The image capture recipe is a file specifying the image capture sequence for imaging the EPs without a position deviation and with a high precision and the scanning charged particle microscope operates based on the image capture recipe. Once the image capture recipe is created, wafers having the same circuit pattern can be automatically inspected any number of times. Further, by sharing the recipe among a plurality of scanning charged particle microscopes, a plurality of wafers can be inspected in parallel. Further, for similar wafers, an image capture recipe therefor can be created in a short time, by modifying the above described image capture recipe more or less.

(6) In the evaluation pattern determination step described in the item (1), it is characterized in that a plurality of patterns that are electrically interconnected to each other are specified based on positions of contact holes and the plurality of patterns are set as the evaluation pattern.

For example, it is characterized in that, in determination of a problem position when finding an electrical fault such as a disconnection, not only a circuit pattern represented as one closed figure is inspected as the evaluation pattern, but also patterns that are electrically interconnected to the circuit pattern are included in the evaluation pattern and inspected. Here, it is difficult to determine an electrical interconnecting relationship between two patterns present in respective different layers, for stacked layers of the circuit pattern in the wafer. Thus, the interconnecting relationship is determined based on the positions of the contact holes that interconnect patterns in different layers to each other. The positions of the contact holes can be determined from design data, captured images or the like.

(7) In the image capture region determination step described in the item (1), it is characterized in that the image capture region is determined in consideration of attribute information in each part of the evaluation pattern. The attribute information is information determining a priority of inspection, such as a deformation property of the pattern. In other words, in addition to the determination criterion of the EP in which the distance between adjacent EPs satisfies the specified permissible distance value as described item (1), the attribute information such as the deformation property of the pattern can be considered for the evaluation pattern in the EPs. The deformation property of the pattern can be expected with litho-simulation of the shape of the circuit pattern equipped in an EDA (Electronic Design Automation) tool, for example. Further, attribute information about the deformation property of the pattern can be calculated from the pattern shape by introducing knowledge about deformation of the pattern shape, such as “corners of the pattern are in danger of being rounded”, “an isolation pattern is in danger of being thinner”, “a line end is in danger of being retracted”.

The EP determination criterion wherein the distance between adjacent EPs satisfies the specified permissible distance value described in the item (1) has viewpoints of avoiding redundant imaging with too much overlap, avoiding non-uniformity of image capture points, and the like. On the other hand, an EP determination criterion based on attribute information such as the deformation property of the evaluation pattern described in the item (7) has a viewpoint of preferentially imaging a place where a defect is likely to occur. In EP determination, either or both of these criteria may be used.

(8) In the image capture region determination step and imaging step described in the item (1), it is characterized to estimate a position of the evaluation pattern outside a first image capture region based on a first image obtained by imaging the first image capture region and set a second image capture region so that the estimated evaluation pattern is imaged.

As an embodiment of a case where information such as the design data cannot be used and the position and shape of the evaluation pattern cannot be previously recognized, the evaluation pattern included in the captured image is recognized from the image and if it is determined that the evaluation pattern continues to outside the image, a next image capture position is determined so that the evaluation pattern outside the image is included in the field of vision and imaging is performed. By repeating this process, images can be captured while tracking the evaluation pattern. Further, the image capture sequence determined here while imaging can be recorded and saved as the image capture recipe.

The determination modes of the image capture sequence are roughly categorized into three modes: an off-line determination mode determining the image capture sequence before imaging, by previously recognizing the position and shape of the evaluation pattern using the design data or the like, as described in the items (2) and (3); an on-line determination mode determining the image capture sequence based on captured images, in the course of repetition of imaging, as described in the item (8); and a combined determination mode using both of the off-line determination mode and the on-line determination mode. Supplemental explanation about the last mode, i.e. the combined determination mode, will be described. In this mode, firstly, the image capture sequence is determined off-line with the design data or the like according to the off-line determination mode. However, the design data or the like can be different from the actual pattern shape so that the off-line determination may be not always successful. Thus, imaging is performed according to the image capture sequence that is determined off-line and the image capture sequence is examined based on the currently captured image and changed as required. These three modes can be executed by switching among them with a GUI or the like.

According to the present invention, determination of a cause of a fault found in an electrical test or the like, or determination of a part affecting a process window due to deformation of the pattern shape or the like, even if an electrical fault does not occur, can be quickly performed. Further, the image capture recipe for this inspection can be automatically and rapidly created and reduction in inspection preparation time (recipe creation time) and obviation of operator skills can be expected. It should be noted that the present invention is not limited to the above described embodiments, but includes various variations. For example, the above described embodiments have been described in detail for purposes of clear explanation of the present invention and the present invention is not limited to embodiments including all components described above. Further, a part of a configuration of an embodiment can be replaced by a configuration of another embodiment and it is also possible to add a configuration of other embodiments to a configuration of an embodiment. Further, for a part of a configuration of each embodiment, addition, deletion or substitution of other configurations is possible.

Additionally, a part or all of configurations, features, processing parts, processing means or the like described above can be realized in hardware, e.g. designed with integrated circuits. Further, configurations, features or the like described above may be realized in software, in such a manner that a processor interprets and runs a program realizing each feature. Information such as programs, tables, files or the like realizing each feature can be stored in a recording device such as a memory, a hard disk, a SSD (Solid State Drive) or the like, or a recording medium such as an IC card, a SD card, a DVD or the like.

Further, only control lines and information lines which are considered to be required for the purpose of explanation are shown and not all control lines and information lines in a manufactured article may be shown. In practice, it may be considered that almost all configurations are connected to each other.

### REFERENCE SIGNS LIST

100 . . . circuit pattern, 101, 102 . . . mouse cursor, 103-111, 113-118 . . . image capture range of evaluation point (EP), 112, 119 . . . distance between EPs, 120 . . . a part of the pattern 100, 200 . . . x-y-z coordinates (coordinates of electro-optical system), 201 . . . semiconductor wafer, 202 . . . electro-optical system, 203 . . . electron gun, 204 . . . electron ray (primary electron), 205 . . . condenser lens, 206 . . . deflector, 207 . . . ExB deflector, 208 . . . objective lens, 209 . . . secondary electron detector, 210, 211 . . . backscattered electron detector, 212-214, 215 . . . processing and control part, 216 . . . CPU, 217 . . . image memory, 218, 225 . . . processing terminal, 219 . . . stage controller, 220 . . . deflector control part, 221 . . . stage, 222 . . . recipe creating part, 223 . . . image capture recipe generating device, 224 . . . measurement recipe generating device, 226 . . . database server, 227 . . . database (storage), 301-306 . . . incident direction of focused electron ray, 307 . . . surface of sample, 308 . . . Ix-Iy coordinates (image coordinates), 309 . . . image, 416 . . . wafer, 417-420 . . . chip to be aligned, 421 chip, 422 . . . image capture range of OM alignment pattern, 423 . . . image capture range of autofocus pattern for SEM alignment pattern imaging, 424 . . . image capture range of SEM alignment pattern, 425 . . . partly enlarged range of design data, 426 . . . MP, 427 . . . range in which image shift can be performed from MP, 428 AF, 429 . . . AP, 430 . . . AF, 431 . . . AST, 432 . . . ABCC, 433 . . . EP, 500, 501, 506, 507, 510, 511, 514, 515, 518, 519 . . . EP, 502, 503 . . . center of EP, 504, 505, 508, 509, 512, 513, 517, 521, 522 . . . distance between EPs, 516, 520 . . . evaluation pattern, 700, 747 . . . evaluation pattern, 701-704, 722-725, 748-750 . . . EP (setting point), 705-708, 727-730, 731 . . . maximum image capture deviation range, 709-712, 732-735, 736 . . . maximum image capture deviation amount in x direction, 713-716, 737-740, 741 . . . maximum image capture deviation amount in y direction, 717-720, 742-745 . . . actually imaged EP position, 726 . . . AP (setting point), 746 . . . actually imaged AP position, 800 . . . pattern, 801, 802, 821 . . . mouse cursor, 803, 804 . . . a part of pattern 800, 805-819 . . . EP, 900, 901, 917, 918 . . . upper layer pattern, 902, 903, 919, 920 . . . lower layer pattern, 904, 905 . . . contact hole, 906, 907 . . . mouse cursor, 908-916, 921-929 . . . EP, 930 . . . electrical path between mouse cursor points 906, 907, 1001-1014 . . . EP, 1015, 1016 . . . electrical path between mouse cursor points 906, 907, 1100-1102 . . . pattern, 1103-1108 . . . a part of pattern 1101, 1109-1116, 1124-1130 . . . EP, 1117-1123, 1131-1136 . . . distance between EPs, 1300, 1310, 1312, 1315 . . . pattern, 1301-1308 . . . EP, 1309 . . . distance between EPs, 1314, 1317 . . . direction in which expected pattern continues, 1313, 1316 . . . motion vector between EPs, 1401, 1402 . . . pattern, 1403-1410, 1414-1421 . . . EP, 1411, 1422 . . . AP, 1423-1425 . . . direction in which expected pattern continues, 1501 . . . mask pattern design device, 1502 . . . mask drawing device, 1503 . . . exposing and developing device, 1504 . . . etching device, 1505, 1507 . . . SEM device, 1506, 1508 . . . SEM controlling device, 1509 . . . EDA tool server, 1510 . . . database server, 1511 . . . database, 1512 . . . image capture and measurement recipe creating arithmetic device, 1513 . . . image capture and measurement recipe server, 1514 . . . image processing server (shape measurement and evaluation), 1515 . . . network, 1516 . . . integration server and arithmetic device for EDA tool, database management, image capture and measurement recipe creation, image processing (shape measurement and evaluation), image capture and measurement recipe management, SEM control, 1601 . . . GUI window, 1602 . . . pattern layout and image capture sequence display window, 1603, 1617 . . . EP, 1604, 1618 . . . evaluation pattern risk position, 1605, 1619 . . . display data selection window, 1606, 1620 . . . display method selection window, 1607 . . . off-line determination mode setting window, 1608 . . . processing data selection window, 1609, 1625 . . . processing parameter setting window, 1610 . . . permissible distance value setting window, 611 . . . EP size setting box, 1612 . . . permissible image capture deviation amount setting box, 1613 . . . image capture sequence optimization executing button, 1614 . . . image capture sequence confirming button, 1615, 1627 . . . image capture recipe saving button, 1616 . . . captured image display window, 1621 . . . image capture control setting window, 1622 image capture method setting window, 1623 image capture recipe specification box, 1624 . . . combined determination mode selection check box, 1626 . . . image capture starting button, 1700 . . . evaluation pattern in which pattern normality and abnormality are displayed in gray scale, 1701 . . . gauge of gray scale value, 1702 . . . risk position

1. A method for evaluating a circuit pattern including:
a permissible distance value specification step of specifying a permissible distance value, the permissible distance value being a permissible value of a distance between adjacent first image and second image included in a plurality of images obtained by imaging an evaluation pattern;
an image capture region determination step of determining an image capture region which includes at least a part of the evaluation pattern and in which adjacent images satisfy the permissible distance value specified in the permissible distance value specification step; and
an image capture step of performing imaging of the evaluation pattern in the image capture region determined in the image capture region determination step to obtain a plurality of images.

2. The method for evaluating the circuit pattern according to claim 1, characterized by further including
an evaluation pattern determination step of determining the evaluation pattern which is a particular circuit pattern among the circuit patterns formed on the semiconductor wafer.

3. The method for evaluating the circuit pattern according to claim 1, characterized in that
in the image capture region determination step, the image capture region is determined based on design data of the circuit pattern including at least the evaluation pattern.

4. The method for evaluating the circuit pattern according to claim 1, characterized in that
in the image capture region determination step, a low magnification image of a region including at least the evaluation pattern is previously obtained with a scanning charged particle microscope or an optical microscope, the low magnification image being captured with a lower image capture magnification than the image capture magnification in the image capture step, and the image capture region is determined based on the low magnification image.

5. The method for evaluating the circuit pattern according to claim 1, characterized in that
in the imaging step, the image capture position of a m-thly imaged image is estimated based on the m-thly imaged image and a stage shift amount or image shift amount to the image capture position of an n-thly (n>m) imaged EP is adjusted based on the estimated image capture position.

6. The method for evaluating the circuit pattern according to claim 1, characterized in that
in the image capture region determination step, an image capture sequence for imaging the image capture region is determined and the image capture sequence is saved as the image capture recipe.

7. The method for evaluating the circuit pattern according to claim 2, characterized in that
in the evaluation pattern determination step, a plurality of patterns which are electrically interconnected to each other are determined based on positions of contact holes formed in the semiconductor wafer and the plurality of patterns are set as the evaluation pattern.

8. The method for evaluating the circuit pattern according to claim 1, characterized in that
in the image capture region determination step, the image capture region is determined in consideration of attribute information for each part of the evaluation pattern.

9. The method for evaluating the circuit pattern according to claim 8, characterized in that
the attribute information includes a deformation property of the pattern.

10. The method for evaluating the circuit pattern according to claim 1, characterized in that
in the imaging step, a position of the evaluation pattern outside a first image capture region of the semiconductor wafer is estimated based on a first image obtained by imaging the first image capture region
in the image capture region determination step, a second image capture region is set so that the estimated evaluation pattern is imaged.

11. An apparatus for evaluating a circuit pattern comprising:
a permissible distance value specification part of specifying a permissible distance value, the permissible distance value being a permissible value of a distance between adjacent first image and second image included in a plurality of images obtained by imaging an evaluation pattern;
an image capture region determination part of determining an image capture region which includes at least a part of the evaluation pattern and in which adjacent images satisfy the permissible distance value specified in the permissible distance value specification part; and
an image capture part of performing imaging of the evaluation pattern in the image capture region determined in the image capture region determination part to obtain a plurality of images.

12. The apparatus for evaluating the circuit pattern according to claim 11, characterized by further comprising
an evaluation pattern determination part of determining the evaluation pattern which is a particular circuit pattern among the circuit patterns formed on the semiconductor wafer.

13. The apparatus for evaluating the circuit pattern according to claim 11, characterized in that
in the image capture region determination part, the image capture region is determined based on design data of the circuit pattern including at least the evaluation pattern.

14. The apparatus for evaluating the circuit pattern according to claim 11, characterized in that
in the image capture region determination part, a low magnification image of a region including at least the evaluation pattern is previously obtained with a scanning charged particle microscope or an optical microscope, the low magnification image being captured with a lower image capture magnification than the image capture magnification in the image capture part, and the image capture region is determined based on the low magnification image.

15. The apparatus for evaluating the circuit pattern according to claim 11, characterized in that
in the imaging part, the image capture position of a m-thly imaged image is estimated based on the m-thly imaged image and a stage shift amount or image shift amount to the image capture position of an n-thly (n>m) imaged EP is adjusted based on the estimated image capture position.

16. The apparatus for evaluating the circuit pattern according to claim 11, characterized in that
in the image capture region determination part, an image capture sequence for imaging the image capture region is determined and the image capture sequence is saved as the image capture recipe.

17. The apparatus for evaluating the circuit pattern according to claim 12, characterized in that
in the evaluation pattern determination part, a plurality of patterns which are electrically interconnected to each other are determined based on positions of contact holes formed in the semiconductor wafer and the plurality of patterns are set as the evaluation pattern.

18. The apparatus for evaluating the circuit pattern according to claim 11, characterized in that
in the image capture region determination part, the image capture region is determined in consideration of attribute information for each part of the evaluation pattern.

19. The apparatus for evaluating the circuit pattern according to claim 18, characterized in that
the attribute information includes a deformation property of the pattern.

20. The apparatus for evaluating the circuit pattern according to claim 11, characterized in that
in the imaging part, a position of the evaluation pattern outside a first image capture region of the semiconductor wafer is estimated based on a first image obtained by imaging the first image capture region
in the image capture region determination part, a second image capture region is set so that the estimated evaluation pattern is imaged.
